(19) United States
(12) Patent Application Publication
(10) Pub. No.: US 2006/0191968 A1
(43) Pub. Date: Aug. 31, 2006

(54) "D" section side rail/cross rail attachment system

(75) Inventors: Craig Stapleton, St. Clair, MI (US); Serge Moreau, Newmarket (CA); Jeffrey J. Meikle, Utica, MI (US)

Correspondence Address: Warn, Hoffmann, Miller & LaLone, P.C., P.O. Box 70098, Rochester Hills, MI, 48307, US

(73) Assignee: Magna International Inc., Aurora (CA)

(21) Appl. No.: 11/357,675

(22) Filed: Feb. 17, 2006

Related U.S. Application Data
(60) Provisional application No. 60/656,952, filed on Feb. 28, 2005.

(51) Int. Cl. B60R 9/00

(52) U.S. Cl. 224/325

(57) ABSTRACT

Cargo rack systems include a side rail that is attached to stanchions mounted on a vehicle's roof portion. The side rail includes a channel formed on a top surface thereof, wherein a fastening member secures the side rail to the stanchions, such that the fastening member is recessed in the channel. The cross rails are fastened to a stanchion that fits over the cross rail. Any number of different combinations of cargo rack systems may be attached to the vehicle's roof portion. The systems also include a side rail member, a stanchion member, a clamp member having a flange portion extending therefrom, and a side rail member, wherein the flange portion is operable to engage a portion of the side rail member, wherein the flange portion is substantially L-shaped, wherein a substantially D-shaped portion of the side rail member is operable to engage the L-shaped flange portion.

### CROSS-REFERENCE TO RELATED APPLICATION

The instant application claims priority to U.S. Provisional Patent Application Ser. No. 60/656,952, filed Feb. 28, 2005, the entire specification of which is expressly incorporated herein by reference.

### FIELD OF THE INVENTION

The present invention relates to a cargo rack for motor vehicles. More specifically, the present invention relates to cargo rack systems for a motor vehicle including easily assembled and/or disassembled side rail and cross rail members corresponding to various vehicle brands, vehicle brand models, and trim packages. The present invention also relates to easily assembled and/or disassembled cross rail members that can be fastened to the side rail members at an infinite, or at least a predetermined number, of positions.

### BACKGROUND OF THE INVENTION

Cargo racks for motor vehicles are generally well known in the art. Many vehicles have cargo racks comprising frames and/or rails on their exterior surfaces, such as their roof, on which luggage or other cargo can be placed for transport. Typically, such cargo racks include strips or rails on which the cargo is placed to prevent the cargo from directly contacting the vehicle surface to prevent damage thereto and/or to spread the load of the cargo over a larger area of the vehicle surface to prevent deformation of vehicle body panels. Further, cargo racks typically provide some mechanism, such as surrounding rails, tie downs and/or enclosures to prevent undesired movement of the cargo on the surface and to keep the cargo on the cargo rack while the vehicle moves.

Conventional factory installed roof racks, with adjustable cross rails, are typically designed and developed anew. That is, all the new components, such as the side and cross rail sections, cross rail mechanisms for attaching to the side rails, supports (e.g., stanchions), and the like, are designed every time a new roof rack is needed, e.g., for a new vehicle brand, a new vehicle brand model, or a particular trim package.

As a result of the new design requirements, the consumer is thus faced with several different potential types of new cross rail latching and unlatching mechanisms, e.g., for every vehicle brand, vehicle brand model, and/or trim package. One typical complaint from consumers is the apparent confusion as to how the cross rail mechanisms are supposed to operate. The likely cause of this confusion is that the operation of the current mechanisms is not readily obvious, as some mechanisms are the push button type, slide button type, pull lever type, push lever type, or the like.

Additionally, some vehicle manufacturers have expressed the desire to create a relatively thin gauge steel side rail member that is capable of providing an infinite number of, or at least a predetermined number of, attachment points for the cross rail members to be secured to the side rail members of the cargo rack system. Currently, conventional cargo rack systems do not provide such configurations and features, and as a result, are relatively difficult and expensive to design and produce. Some vehicle manufacturers have attempted to provide a solution to this problem by producing a side rail member that is double wrapped with material and/or provided with a hem flange. However, this only resulted in increasing the cargo rack system's part weight, material consumption, part complexity, cost and product variation.

Accordingly, there exists a need for new and improved cargo rack systems that are simple and inexpensive to manufacture, easily operated (e.g., assembled and/or disassembled) by consumers, and aesthetically pleasing. Furthermore, there exists a need for new and improved cargo rack systems that provide for cross rail members that can be easily and quickly fastened to the side rails members at an infinite, or at least a predetermined number, of positions.

### SUMMARY OF THE INVENTION

It is an object of the present invention to provide a new and improved cargo rack system for motor vehicles which obviates at least one disadvantage of the prior art.

It is an object of the present invention to provide a new, simple, low cost, structural cargo rack system based on the industries best practices for structure, aerodynamics, material, finish, processing, mechanisms, and the like.

It is an object of the present invention to provide a side rail section that will be designed to be used as a raised or flush mount application and to be exposed so that the rail can have different finishes that are visible for each vehicle trim level if a distinctive look is required.

It is an object of the present invention to provide a side rail section will be a carry over structural component for all of the automaker's vehicle lines, wherein the section will be used on all new cargo rack systems.

It is an object of the present invention to provide a cross rail section that will be designed to the industries best practices to eliminate wind noise and to have the required structure.

It is an object of the present invention to provide a cross rail section that will be designed so that the rail can have different finishes for each vehicle trim level if a distinctive look is required.

It is an object of the present invention to provide a cross rail section that will be a carry over structural component for all of the automakers vehicle lines, wherein the section will be used on all new cargo rack systems.

It is an object of the present invention to provide cross rail systems that are easily adjustable and removable.

It is an object of the present invention to provide a cross rail mechanism design that is simple, structural, and based on the industries best practices, wherein the mechanism will be a carry over system for all of the automaker's vehicle lines.

It is an object of the present invention to provide attachment components to the vehicle that varies in styling and finish to give the rack a unique look from one vehicle to another.

It is an object of the present invention to provide a new and improved cross rail system for a cargo rack system for motor vehicles.

It is an object of the present invention to provide a new and improved cross rail member for a cargo rack system for motor vehicles, wherein the cross rail member can be positioned at an infinite number of positions relative to a side rail member.

It is an object of the present invention to provide a new and improved cross rail member for a cargo rack system for motor vehicles, wherein the cross rail member can be positioned at a predetermined number of positions relative to a side rail member.

The present invention preferably reduces the time required to develop and tool a new rack system. For example, the only new components to design and engineer are the attachment components to the vehicle roof panel.

The present invention preferably utilizes carry over, proven structural, aerodynamic and mechanical components. For example, this eliminates the concerns for validation and problems that can occur at launch of the new product.

The present invention, by using carry over sections and mechanisms, will preferably improve the production efficiency of the rack manufacturer. For example, this will lower cost of the product and tooling is reduced due to only a few new components (e.g., attachment components) are required to engineer, design and tool.

The present invention, by using carry over simplified cross rail mechanism for all models and makes, will preferably reduce any confusion by the end user on how the mechanism operates is reduced.

The present invention, by changing finishes and the styling of the attachment components, will preferably enable a distinct rack appearance that can be achieved for different trim levels and car lines.

The present invention preferably takes into full consideration the industry best practices for structure, aerodynamics, material, finish, processing, mechanisms, and the like that were derived from the best of the current practices in the industry.

In accordance with the general teachings of the present invention, new and improved cargo rack systems are provided. In accordance with a preferred embodiment of the present invention, the cargo rack systems are simple and inexpensive to manufacture, easily operated (e.g., assembled and/or disassembled) by consumers, and aesthetically pleasing.

In accordance with a first embodiment of the present invention, a cargo rack system is provided, comprising: (1) a stanchion member fastened to a roof portion of a vehicle, the stanchion member having a receptacle formed therein operable to receive a fastening member; (2) a side rail member having a bore formed in a surface thereof; and (3) a fastening member operable to fasten a portion of the side rail member to a portion of the stanchion member, wherein the fastening member is substantially recessed into the receptacle when the side rail member is fastened to the stanchion member so as to substantially obscure the fastening member from view.

In accordance with a second embodiment of the present invention, a cargo rack system is provided, comprising: (1) a stanchion member fastened to a roof portion of a vehicle, the stanchion member having a receptacle formed therein operable to receive a fastening member; (2) a side rail member having a through bore formed in a surface thereof; (3) a fastening member operable to fasten a portion of the side rail member to a portion of the stanchion member, wherein the fastening member is substantially recessed into the receptacle when the side rail member is fastened to the stanchion member so as to substantially obscure the fastening member from view; (4) a cross rail member; and (5) a stanchion assembly operable to fasten a portion of the cross rail member to the side rail member.

In accordance with a third embodiment of the present invention, a cargo rack system is provided, comprising: (1) a stanchion member fastened to a roof portion of a vehicle, the stanchion member having a receptacle formed therein operable to receive a fastening member; (2) a side rail member having a bore formed in a surface thereof; (3) a fastening member operable to fasten a portion of the side rail member to a portion of the stanchion member, wherein the fastening member is substantially recessed into the receptacle when the side rail member is fastened to the stanchion member so as to substantially obscure the fastening member from view; (4) a cross rail member; and (5) a stanchion assembly operable to fasten a portion of the cross rail member to the side rail member, wherein the stanchion assembly includes a second stanchion member, a clamp member, and a second fastening member, wherein the second stanchion member and the clamp member are operable to envelope a portion of the side rail member, wherein the second fastening member fastens the second stanchion member and the clamp member together when the second stanchion member and the clamp member envelope a portion of the side rail member.

In accordance with a fourth embodiment of the present invention, a cargo rack system is provided, comprising: (1) a stanchion member fastened to a roof portion of a vehicle, the stanchion member having a receptacle formed therein operable to receive a fastening member; (2) a side rail member having a bore formed in a surface thereof; (3) a fastening member operable to fasten a portion of the side rail member to a portion of the stanchion member, wherein the fastening member is substantially recessed into the receptacle when the side rail member is fastened to the stanchion member so as to substantially obscure the fastening member from view; (4) a cross rail member; (5) a second fastening member; and (6) a stanchion assembly operable to fasten a portion of the cross rail member to the side rail member, wherein the second fastening member is operable to fasten the cross rail member and the stanchion assembly when the cross rail member and the stanchion assembly are brought into nesting engagement, wherein the stanchion assembly includes a second stanchion member, a clamp member, and a third fastening member, wherein the second stanchion member and the clamp member are operable to envelope a portion of the side rail member, wherein the third fastening member fastens the second stanchion member and the clamp member together when the second stanchion member and the clamp member envelope a portion of the side rail member.

In accordance with a fifth embodiment of the present invention, a side rail system is provided, comprising: (1) a side rail member; (2) a stanchion member, wherein the side rail member is operable to receive a portion of the stanchion member; and (3) a clamp member in abutting engagement with the stanchion member, the clamp member having a flange portion extending therefrom.

In accordance with a sixth embodiment of the present invention, a cargo rack system is provided, comprising: (1) a side rail member; (2) a stanchion member, wherein the side rail member is operable to receive a portion of the stanchion member; (3) a clamp member in abutting engagement with the stanchion member, the clamp member having a flange portion extending therefrom; and (4) a side rail member, wherein the flange portion is operable to engage a portion of the side rail member.

In accordance with a seventh embodiment of the present invention, a cargo rack system is provided, comprising: (1) a side rail member; (2) a stanchion member, wherein the side rail member is operable to receive a portion of the stanchion member; (3) a clamp member in abutting engagement with the stanchion member, the clamp member having a flange portion extending therefrom; (4) a side rail member, wherein the flange portion is operable to engage a portion of the side rail member, wherein the flange portion is substantially L-shaped, wherein a substantially D-shaped portion of the side rail member is operable to engage the L-shaped flange portion of the clamp member; (5) a threaded plate member in abutting engagement with a surface of the clamp member; and (6) a fastening member, wherein the fastening member is operable to engage the threaded plate member, wherein the fastening member includes an externally threaded stud portion extending therefrom.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a partial perspective view of a side rail system fastened to the roof portion of a vehicle on the driver's side, in accordance with one embodiment of the present invention;

FIG. 2 is a partial perspective view of a side rail system fastened to the roof portion of a vehicle on the passenger's side, in accordance with one embodiment of the present invention;

FIG. 3 is a perspective view of a side rail system, in accordance with one embodiment of the present invention;

FIG. 4 is a partial exploded view of the side rail system depicted in FIG. 3, in accordance with one embodiment of the present invention;

FIG. 5 is a partial sectional view taken along line 5-5 of FIG. 4, in accordance with one embodiment of the present invention;

FIG. 6 is a partial perspective view of a first alternative side rail system fastened to the roof portion of a vehicle on the driver's side, in accordance with a first alternative embodiment of the present invention;

FIG. 7 is a partial perspective view of a first alternative stanchion member, in accordance with a second alternative embodiment of the present invention;

FIG. 8 is a partial perspective view of a second alternative stanchion member, in accordance with a third alternative embodiment of the present invention;

FIG. 9 is a partial perspective view of a third alternative stanchion member, in accordance with a fourth alternative embodiment of the present invention;

FIG. 10 is a partial elevational view of a cargo rack system fastened to the roof portion of a vehicle, in accordance with a fifth alternative embodiment of the present invention;

FIG. 11 is a partial perspective view of the cargo rack system depicted in FIG. 10, in accordance with a fifth alternative embodiment of the present invention;

FIG. 12 is a partial perspective view of a side rail member of the cargo rack system depicted in FIG. 10 fastened to the roof portion of a vehicle on the passenger's side, in accordance with a fifth alternative embodiment of the present invention;

FIG. 13 is a partial perspective view of a side rail member of the cargo rack system depicted in FIG. 10 fastened to the roof portion of a vehicle on the passenger's side, wherein the cross rail members have been removed for the purpose of clarity, in accordance with a fifth alternative embodiment of the present invention;

FIG. 14 is a partial perspective view of a side rail member of the cargo rack system depicted in FIG. 10 fastened to the roof portion of a vehicle on the driver's side, in accordance with a fifth alternative embodiment of the present invention;

FIG. 15 is a partial perspective view of a stanchion member of the cargo rack system depicted in FIG. 10 fastened to the roof portion of a vehicle on the passenger's side, in accordance with a fifth alternative embodiment of the present invention;

FIG. 16 is a partial perspective view of a stanchion assembly for a cross rail member of the cargo rack system depicted in FIG. 10 fastened to the side rail member of the cargo rack system, in accordance with a fifth alternative embodiment of the present invention;

FIG. 17 is a partial perspective view of a rear portion of the stanchion member of the cargo rack system depicted in FIG. 10 fastened to the roof portion of a vehicle on the passenger's side, in accordance with a fifth alternative embodiment of the present invention;

FIG. 18 is a partial perspective view of a second alternative side rail system fastened to the roof portion of a vehicle on the driver's side, in accordance with a sixth alternative embodiment of the present invention;

FIG. 19 is a perspective view of a fourth alternative stanchion member, in accordance with a seventh alternative embodiment of the present invention;

FIG. 20 is a perspective view of a fifth alternative stanchion member, in accordance with an eighth alternative embodiment of the present invention;

FIG. 21 is a partial perspective view of a third alternative side rail system fastened to the roof portion of a vehicle on the driver's side, in accordance with a ninth alternative embodiment of the present invention;

FIG. 22 is a perspective view of a sixth alternative stanchion member, in accordance with a tenth alternative embodiment of the present invention;

FIG. 23 is a perspective view of a seventh alternative stanchion member, in accordance with an eleventh alternative embodiment of the present invention;

FIG. 24 is a partial perspective view of a fourth alternative side rail system fastened to the roof portion of a vehicle on the passenger's side, in accordance with a twelfth alternative embodiment of the present invention;

FIG. 25 is a perspective view of an eighth alternative stanchion member, in accordance with a thirteenth alternative embodiment of the present invention;

FIG. 26 is a perspective view of the side rail system depicted in FIG. 25, in accordance with a fourteenth alternative embodiment of the present invention;

FIG. 27 is a partial exploded view of the side rail system depicted in FIG. 26, in accordance with a fourteenth alternative embodiment of the present invention;

FIG. 28 is a partial sectional view taken along line 28-28 of FIG. 27, in accordance with an fourteenth alternative embodiment of the present invention;

FIG. 29 is a partial perspective view of a fifth alternative side rail system fastened to the roof portion of a vehicle on the driver's side, in accordance with a fifteenth alternative embodiment of the present invention;

FIG. 30 is a perspective view of a ninth alternative stanchion member, in accordance with a sixteenth alternative embodiment of the present invention;

FIG. 31 is a perspective view of a tenth alternative stanchion member, in accordance with a seventeenth alternative embodiment of the present invention;

FIG. 32 is a perspective view of the side rail system depicted in FIG. 29, in accordance with an eighteenth alternative embodiment of the present invention;

FIG. 33 is a partial exploded view of the side rail system depicted in FIG. 32, in accordance with an eighteenth alternative embodiment of the present invention;

FIG. 34 is a partial sectional view taken along line 34-34 of FIG. 32, in accordance with an eighteenth alternative embodiment of the present invention;

FIG. 35 is a partial perspective view of a sixth alternative side rail system fastened to the roof portion of a vehicle on the passenger's side, in accordance with a nineteenth alternative embodiment of the present invention;

FIG. 36 is a perspective view of an eleventh alternative stanchion member, in accordance with a twentieth alternative embodiment of the present invention;

FIG. 37 is a perspective view of a twelfth alternative stanchion member, in accordance with a twenty-first alternative embodiment of the present invention;

FIG. 38 is a partial perspective view of a sixth alternative side rail system fastened to the roof portion of a vehicle on the passenger's side, in accordance with a twenty-second alternative embodiment of the present invention;

FIG. 39 is a perspective view of a tenth alternative stanchion member, in accordance with a twenty-third alternative embodiment of the present invention;

FIG. 40 is a perspective view of the side rail system depicted in FIG. 38, in accordance with a twenty-fourth alternative embodiment of the present invention;

FIG. 41 is a partial exploded view of the side rail system depicted in FIG. 40, in accordance with a twenty-fourth alternative embodiment of the present invention;

FIG. 42 is a partial sectional view taken along line 42-42 of FIG. 40, in accordance with a twenty-fourth alternative embodiment of the present invention;

FIG. 43 is a partial perspective view of a seventh alternative side rail system fastened to the roof portion of a vehicle on the passenger's side, in accordance with a twenty-fifth alternative embodiment of the present invention;

FIG. 44 is a perspective view of the side rail system depicted in FIG. 43, in accordance with a twenty-sixth alternative embodiment of the present invention;

FIG. 45 is a partial exploded view of the side rail system depicted in FIG. 44, in accordance with a twenty-sixth alternative embodiment of the present invention;

FIG. 46 is a partial sectional view taken along line 46-46 of FIG. 45, in accordance with a twenty-sixth alternative embodiment of the present invention;

FIG. 47 is a partial perspective view of an eighth alternative side rail system fastened to the roof portion of a vehicle on the passenger's side, in accordance with a twenty-seventh alternative embodiment of the present invention;

FIG. 48 is a perspective view of the side rail system depicted in FIG. 47, in accordance with a twenty-eighth alternative embodiment of the present invention;

FIG. 49 is a partial exploded view of the side rail system depicted in FIG. 47, in accordance with a twenty-eighth alternative embodiment of the present invention;

FIG. 50 is a partial sectional view taken along line 50-50 of FIG. 49, in accordance with a twenty-eighth alternative embodiment of the present invention;

FIG. 51 is a partial perspective view of an alternative cargo rack system fastened to the roof portion of a vehicle, in accordance with a twenty-ninth alternative embodiment of the present invention;

FIG. 52 is a perspective view of an eleventh alternative stanchion member, in accordance with a thirtieth alternative embodiment of the present invention;

FIG. 53 is a partial perspective view of a first alternative stanchion assembly, in accordance with a thirty-first alternative embodiment of the present invention;

FIG. 54 is a partial exploded view of the side rail system of the cargo rack system depicted in FIG. 51, in accordance with a thirty-first alternative embodiment of the present invention;

FIG. 55 is a partial sectional view taken along line 55-55 of FIG. 54, in accordance with a thirty-first alternative embodiment of the present invention;

FIG. 56 is a partial exploded view of an alternative design of the side rail system of the cargo rack system depicted in FIG. 51, in accordance with a thirty-second alternative embodiment of the present invention;

FIG. 57 is a partial sectional view taken along line 57-57 of FIG. 56, in accordance with a thirty-second alternative embodiment of the present invention;

FIG. 58 is a partial exploded view of a second alternative stanchion assembly of the cargo rack system depicted in FIG. 51, in accordance with a thirty-third alternative embodiment of the present invention;

FIG. 59 is a partial exploded view of an alternative design of the stanchion assembly of the cargo rack system depicted in FIG. 51, in accordance with a thirty-fourth alternative embodiment of the present invention;

FIG. 60 is a partial perspective view of a ninth alternative side rail system fastened to the roof portion of a vehicle on the passenger's side, in accordance with a thirty-fifth alternative embodiment of the present invention;

FIG. 61 is a perspective view of an eleventh alternative stanchion member, in accordance with a thirty-sixth alternative embodiment of the present invention;

FIG. 62 is a perspective view of the side rail system depicted in FIG. 60, in accordance with a thirty-seventh alternative embodiment of the present invention;

FIG. 63 is a partial exploded view of the side rail system depicted in FIG. 62, in accordance with a thirty-seventh alternative embodiment of the present invention;

FIG. 64 is a partial sectional view taken along line 64-64 of FIG. 63, in accordance with a thirty-seventh alternative embodiment of the present invention;

FIG. 65 is an exploded view of a cross rail system of a cargo rack system, in accordance with a thirty-eighth embodiment of the present invention; and

FIG. 66 is a partial sectional view of a cargo rack system, in accordance with a thirty-ninth embodiment of the present invention.

### DETAILED DESCRIPTION OF THE INVENTION

The following description of the preferred embodiment(s) is merely exemplary in nature and is in no way intended to limit the invention, its application, or uses.

The present invention is preferably intended to allow the cargo rack systems and components thereof, to be incorporated onto any vehicle, regardless of manufacturer, brand, model, or trim level. Furthermore, it is intended that the present invention become the industry standard for the manufacture, installation, and/or modification of cargo rack systems and components thereof.

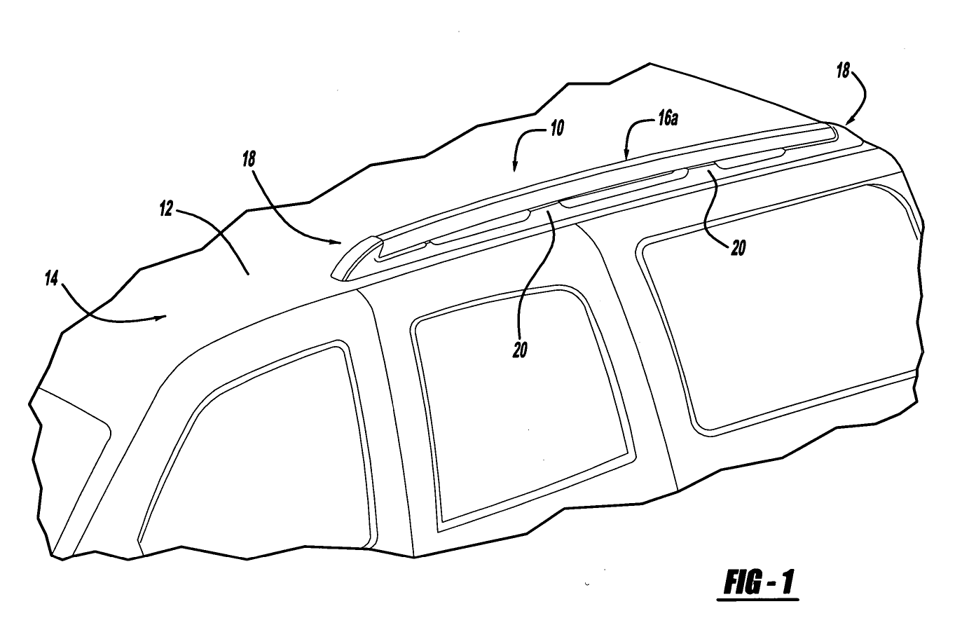

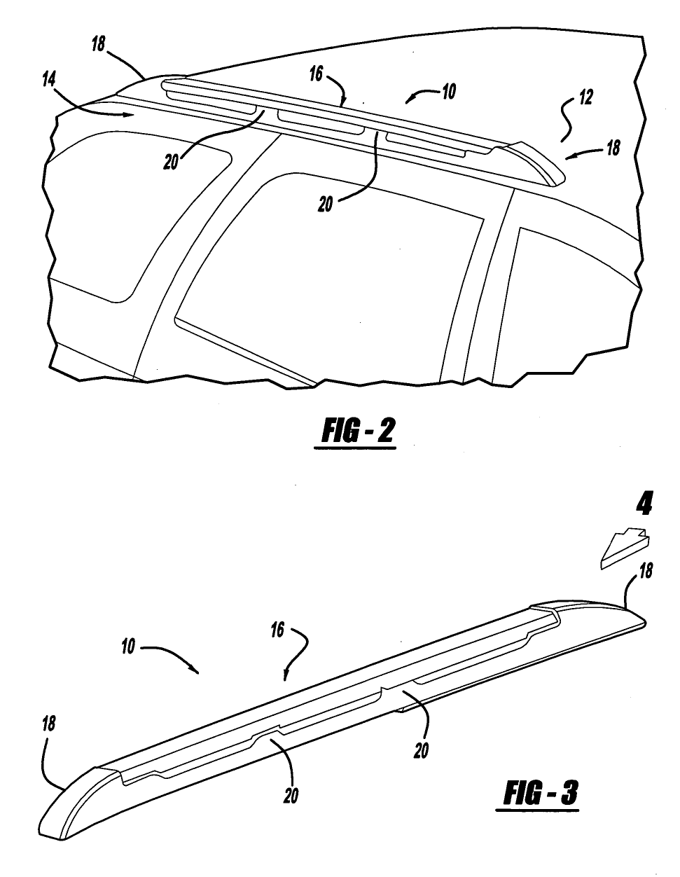

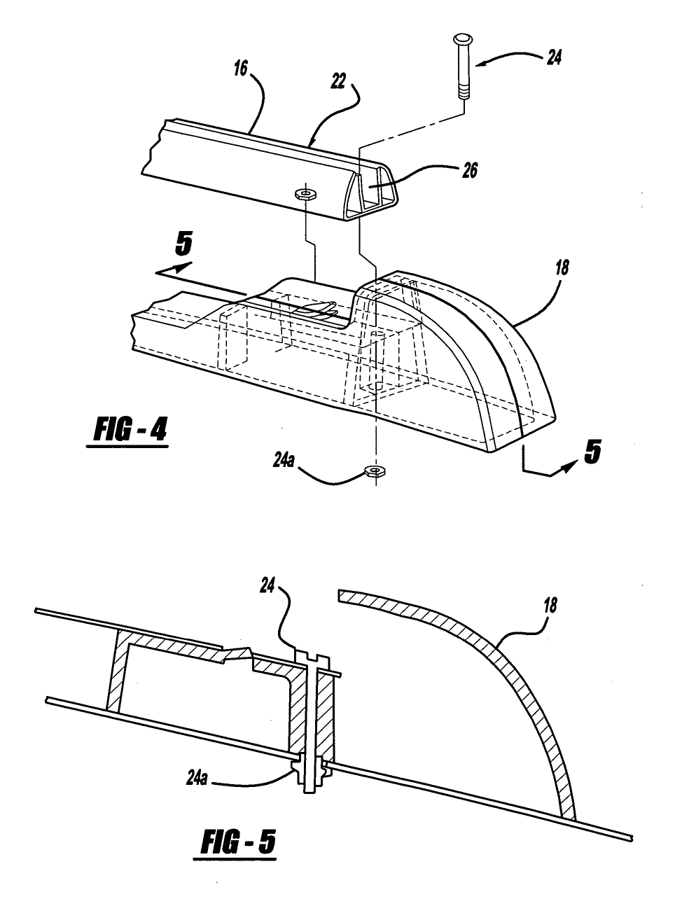

Referring to FIGS. 1-5, there is shown a side rail system 10 fastened to a roof portion 12 of a vehicle 14 on the driver's side, in accordance with one embodiment of the present invention. The system 10 preferably includes one or more side rail members 16 (only one is shown for purposes of clarity), that are preferably easily attached to one or more stanchion members 18 mounted on the roof portion 12. The stanchion members 18 can be configured in any number of shapes, and can include more than one portion (e.g., a front portion and a discontinuous rear portion). Furthermore, the stanchion members 18 can include integrated or discrete support members 20 (e.g., for supporting the side rail members 16a, 16b, respectively).

It should be appreciated that any of the embodiments described herein can include side rail members that are either flush against the stanchion members, flush against the roof portion of the vehicle, raised above the roof portion of the vehicle, raised above the stanchion members, or any combination thereof.

The side rail members 16 preferably include an opening such as a channel portion or a bore 22 formed on a top and/or bottom surface thereof. One or more fastening members 24 (e.g., screws), in conjunction with a nut member 24a, are then preferably employed to secure the side rail member to the stanchion members 18 in a manner wherein the fastening members 24 are substantially obscured from view once installation has taken place.

In accordance with a preferred embodiment of the present invention, the side rail members 16 preferably include a substantially T-shaped slot 26 formed on the top surface thereof. The undersurface of the T-shaped slot 26 preferably includes a spline knurl that interlocks with a stanchion lock plate to prevent the cross rail members 16 from shifting, e.g., when loaded and a panic stop occurs. The section of the side rail members 16 are preferably structural so that it can be used as either a flush mount (e.g., directly abutting the roof surface) or as a raised side rail (e.g., suspended above the roof surface, i.e., supported only at the ends and center portions). The side rail members 16 are preferably designed to be an exposed rail such that finish changes can alter the appearance thereof. In accordance with a preferred embodiment of the present invention, front, rear and center support members 22 close off the ends and support the side rail members 16. The support members 22 add a styling feature to the assembly and they can have molded in features such as but not limited to tie loops. The support members 22 are preferably attached to each end of the side rail members 16 with molded in snaps.

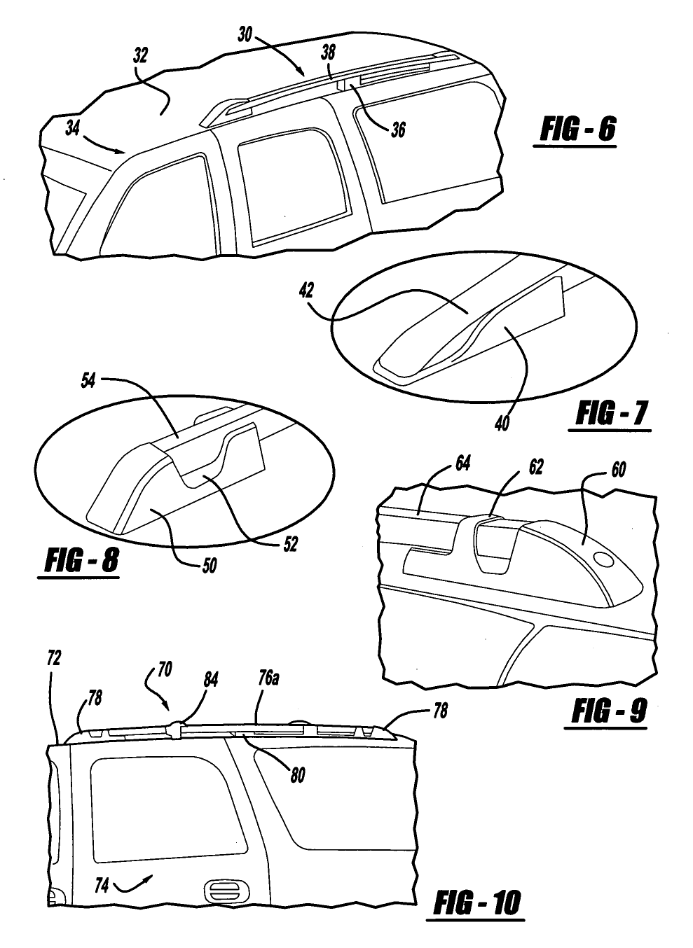

As previously noted, the side rail systems, including the side rail members and the stanchion members can be configured in any number of styles. Referring to FIG. 6, there is shown a partial perspective view of a first alternative side rail system 30 fastened to the roof portion 32 of a vehicle 34 on the driver's side, in accordance with a first alternative embodiment of the present invention. In this view, only one support member 36 is shown, approximately midway along the length of the side rail member 38.

Referring to FIG. 7, there is shown a partial perspective view of a first alternative stanchion member 40, in accordance with a second alternative embodiment of the present invention. In this view, the stanchion member 40 is streamlined and does not envelope the top or upper portions of the side rail member 42.

Referring to FIG. 8, there is shown a partial perspective view of a second alternative stanchion member 50, in accordance with a third alternative embodiment of the present invention. In this view, the stanchion member 50 is provided with a curved cut-out portion 52 which envelopes only a portion of the top or upper portions of the side rail member 54.

Referring to FIG. 9, there is shown a partial perspective view of a third alternative stanchion member 60, in accordance with a fourth alternative embodiment of the present invention. In this view, the stanchion member 60 is provided with a loop portion 62 which extends completely over a top or upper portion of the side rail member 64.

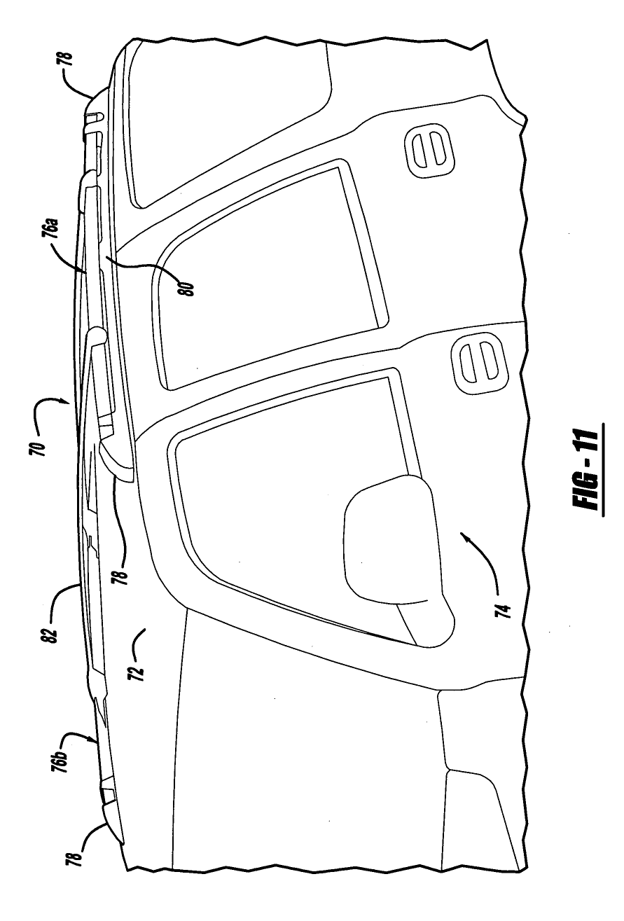

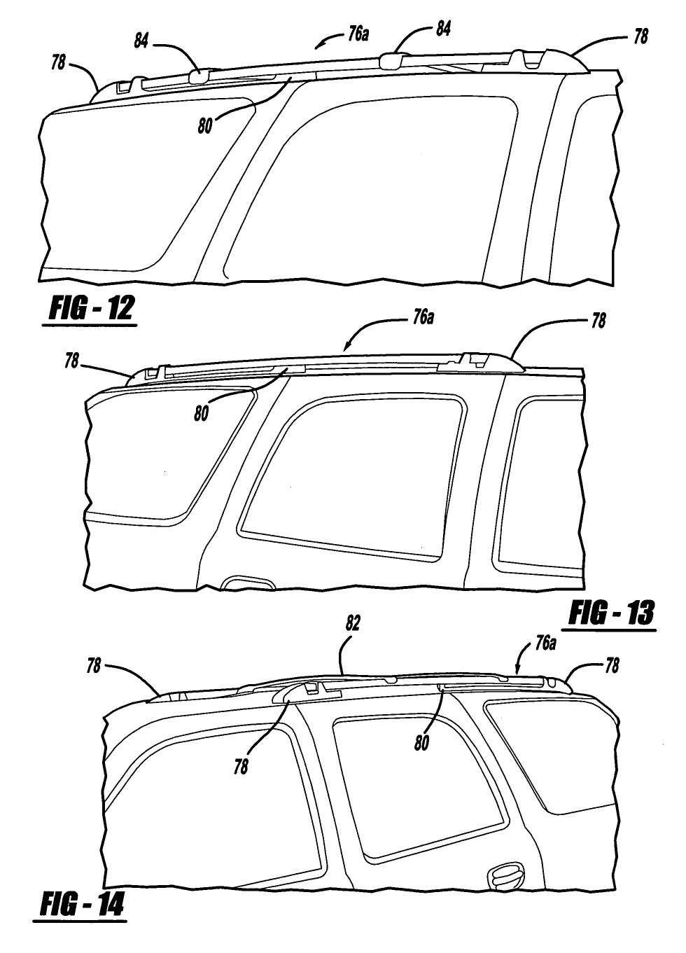

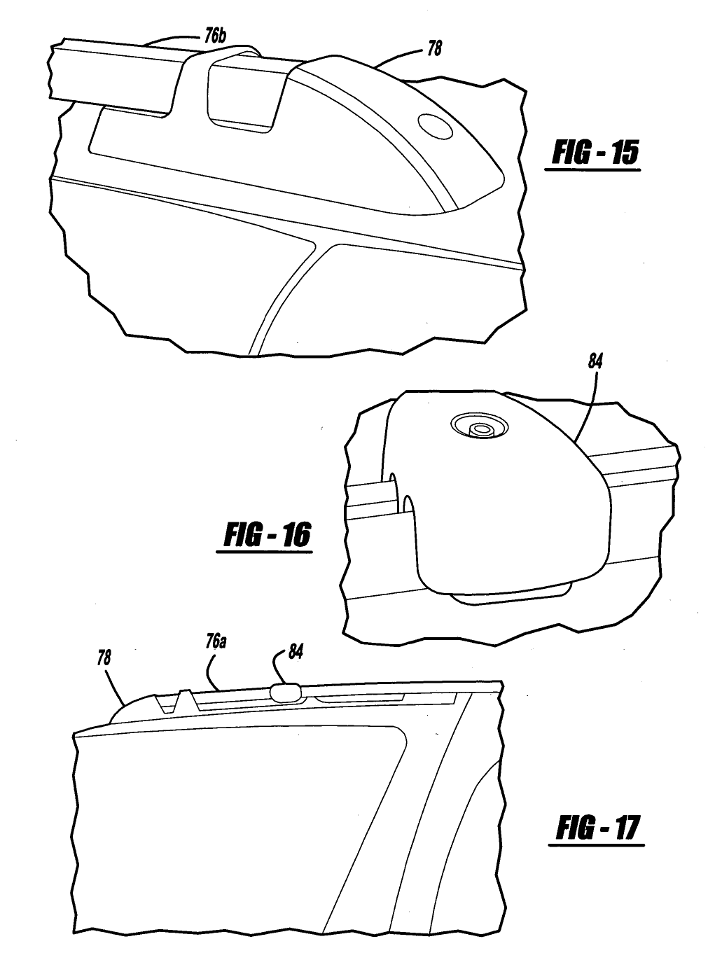

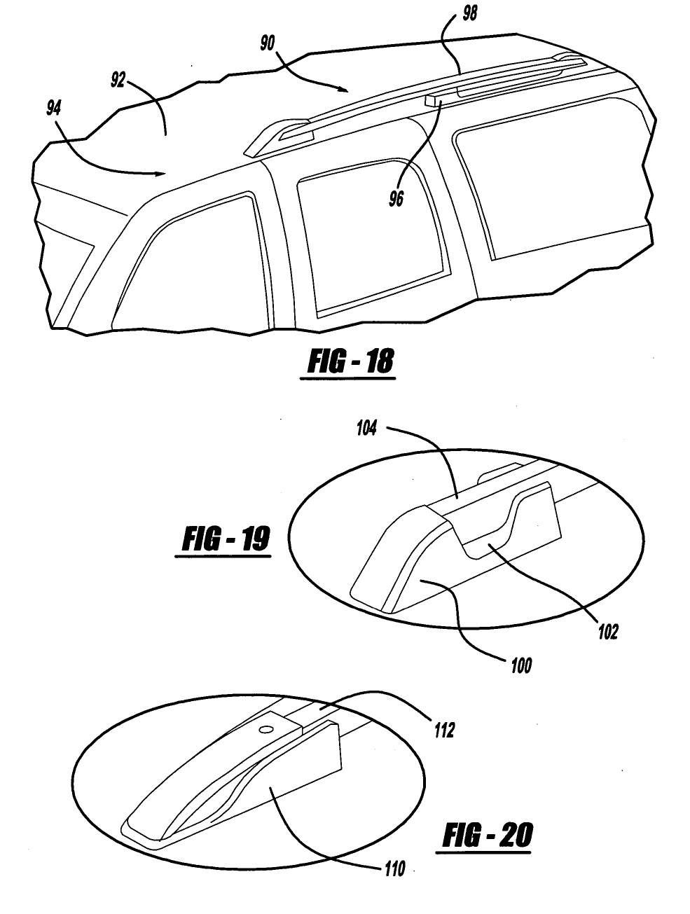

Referring to FIGS. 10-17, there is shown a cargo rack system 70 fastened to a roof portion 72 of a vehicle 74, in accordance with a fifth alternative embodiment of the present invention. The system 70 preferably includes two side rail systems 76a, 76b, respectively, at least one stanchion member 78, at least one support member 80, at least one cross rail member 82, and at least one stanchion assembly 84 operable to connect the cross rail member 82 to the side rail members 76a, 76b, respectively.

The stanchion assembly 84 is preferably very easily assembled and disassembled by the individual user, thus allowing the user to easily remove and replace the cross rail member 82, e.g., to upgrade the trim level, remove the cross rail member and store the same, and/or replace a damaged cross rail member. Additionally, the stanchion assembly 84 allows the user to substantially configure the layout of the individual cross rail members relative to the side rail members 76a, 76b, respectively, to suit the user's cargo particular storage rack needs.

As previously noted, the cargo rack systems, including the side rail members and the stanchion members thereof, can be configured in any number of styles. Referring to FIG. 18, there is shown a partial perspective view of a second alternative side rail system 90 fastened to the roof portion 92 of a vehicle 94 on the driver's side, in accordance with a sixth alternative embodiment of the present invention. In this view, only one support member 96 is shown, approximately midway along the length of the side rail member 98.

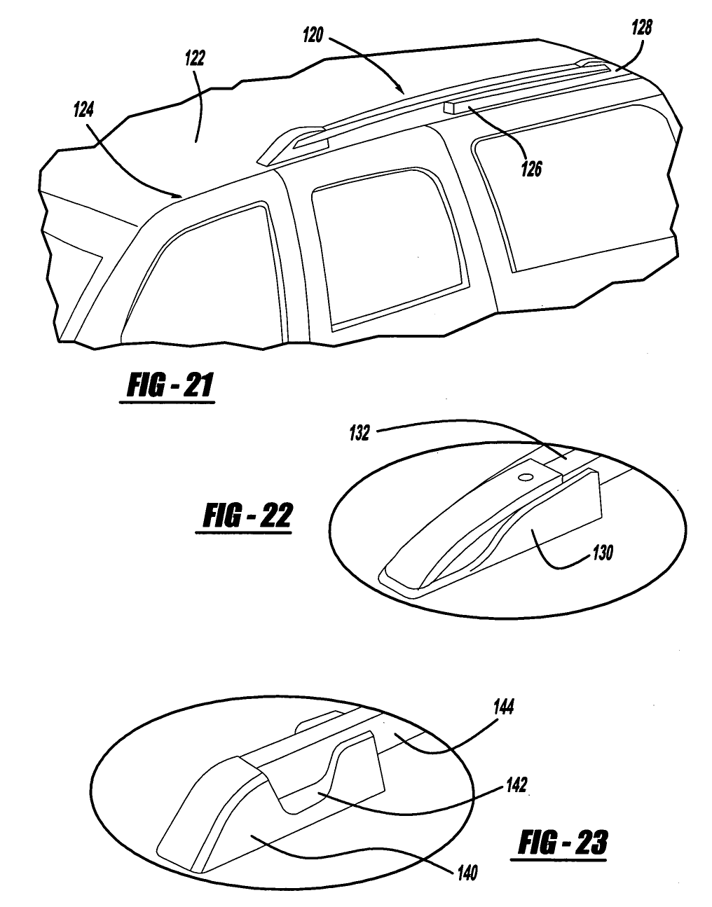

Referring to FIG. 19, there is shown a partial perspective view of a fourth alternative stanchion member 100, in accordance with a seventh alternative embodiment of the present invention. In this view, the stanchion member 100 is provided with a curved cut-out portion 102 which envelopes only a portion of the top or upper portions of the side rail member 104.

Referring to FIG. 20, there is shown a partial perspective view of a fifth alternative stanchion member 110, in accordance with an eighth alternative embodiment of the present invention. In this view, the stanchion member 110 is streamlined and envelopes the top or upper portions of the side rail member 112.

Referring to FIG. 21, there is shown a partial perspective view of a third alternative side rail system 120 fastened to the roof portion 122 of a vehicle 124 on the driver's side, in accordance with a ninth alternative embodiment of the present invention. In this view, the support member 126 is essentially integrated into the rear stanchion member 128 to form a unitary member.

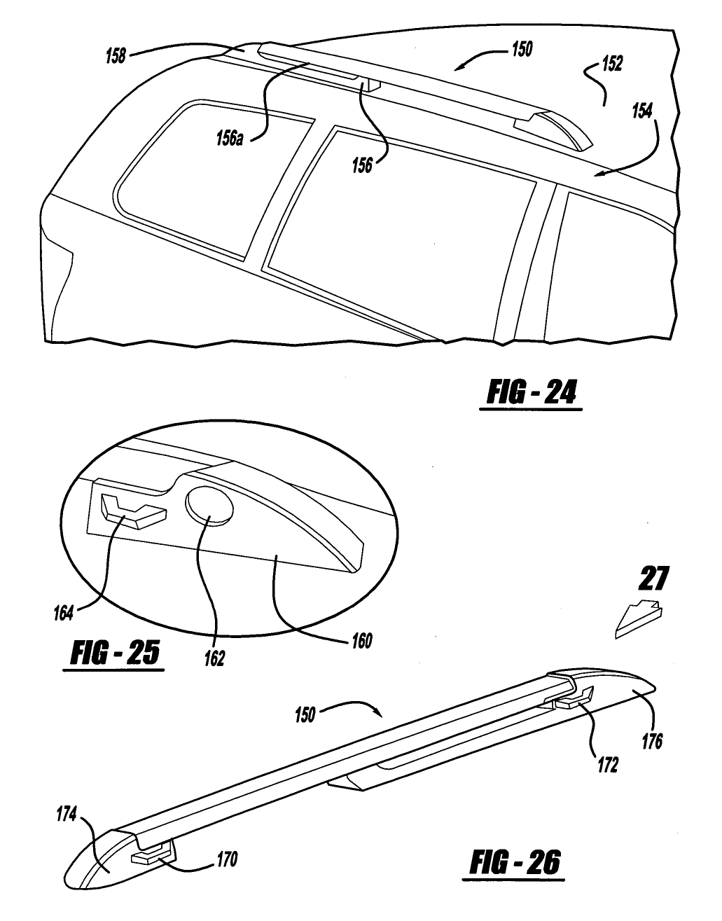

Referring to FIG. 22, there is shown a partial perspective view of a sixth alternative stanchion member 130, in accordance with a tenth alternative embodiment of the present invention. In this view, the stanchion member 130 is streamlined and envelopes the top or upper portions of the side rail member 132.

Referring to FIG. 23, there is shown a partial perspective view of a seventh alternative stanchion member 140, in accordance with an eleventh alternative embodiment of the present invention. In this view, the stanchion member 140 is provided with a curved cut-out portion 142 which envelopes only a portion of the top or upper portions of the side rail member 144.

Referring to FIG. 24, there is shown a partial perspective view of a fourth alternative side rail system 150 fastened to the roof portion 152 of a vehicle 154 on the passenger's side, in accordance with a twelfth alternative embodiment of the present invention. In this view, the support member 156 is essentially integrated into the rear stanchion member 158 to form a unitary member; however, it is not a solid member as shown in FIG. 21, but rather the member contains an area defining a notch portion 156a.

Referring to FIG. 25, there is shown a perspective view of an eighth alternative stanchion member 160, in accordance with a thirteenth alternative embodiment of the present invention. In this view, the stanchion member 160 is provided with at least one area defining a notch portion 162, 164, respectively, which can be used for various purposes, including tie downs.

Referring to FIG. 26, there is shown a perspective view of the side rail system 150 depicted in FIG. 25, in accordance with a fourteenth alternative embodiment of the present invention. In this view, notch portions 170, 172, respectively, are provided on the stanchion members 174, 176, respectively.

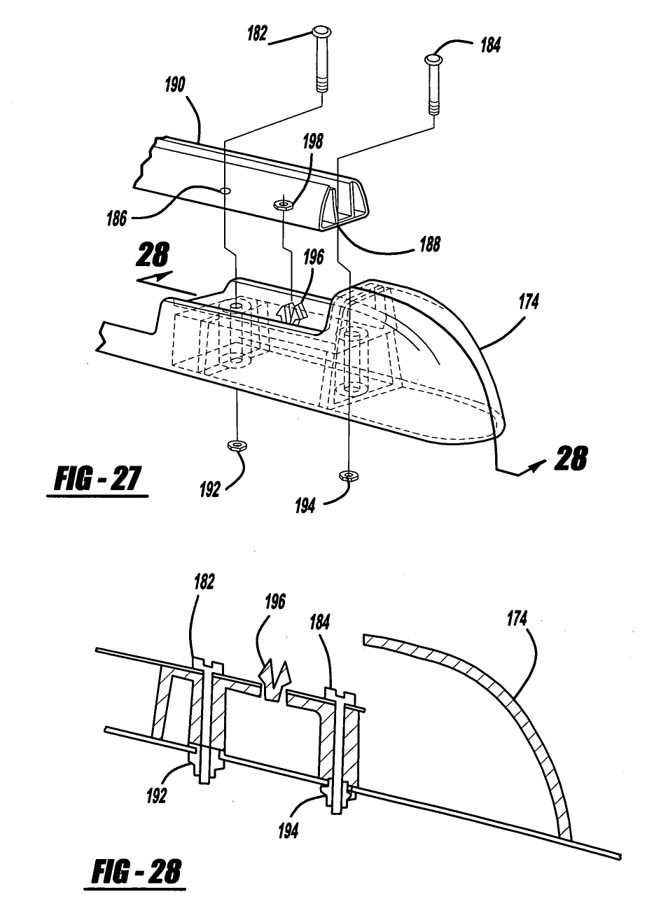

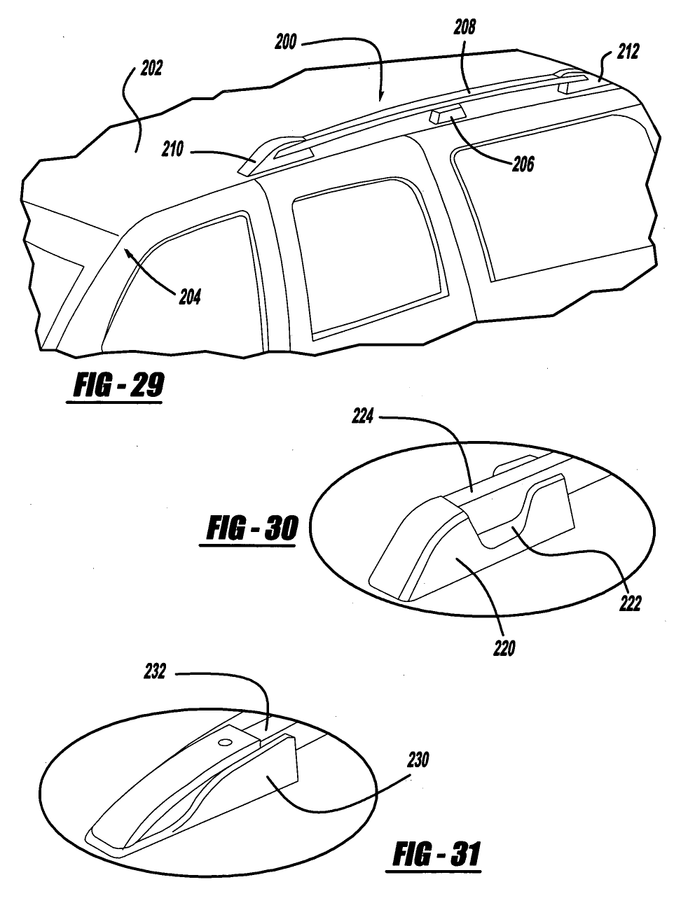

Referring to FIG. 27, there is shown a partial exploded view of the side rail system 150 depicted in FIG. 26, in accordance with a fourteenth alternative embodiment of the present invention. In this view, one or more fastening members (e.g., screws) 182, 184, respectively, are inserted through apertures 186, 188, respectively, formed in a lower surface of the side rail member 190 and received into bores (e.g., threaded bores) formed on a surface of the stanchion members 174, 176, respectively, and inserted into nut members, 192, 194, respectively, thus fastening the side rail member 190 to the stanchion members 174, 176, respectively. Additionally, a biasable locking member 196 can be provided on the stanchion members 174, 176, respectively, which is operable to engage another aperture 198 formed on the lower surface of the side rail member 190. Referring to FIG. 28, there is shown a partial sectional view taken along line 28-28 of FIG. 27, in accordance with a fourteenth alternative embodiment of the present invention.

As previously noted, the cargo rack systems, including the side rail members and the stanchion members thereof, can be configured in any number of styles. Referring to FIG. 29, there is shown a partial perspective view of a fifth alternative side rail system 200 fastened to the roof portion 202 of a vehicle 204 on the driver's side, in accordance with a fifteenth alternative embodiment of the present invention. In this view, only one support member 206 is shown, approximately midway along the length of the side rail member 208. It should be noted that the support member 206 does not contact either of the stanchion members 210, 212, respectively.

Referring to FIG. 30, there is shown a partial perspective view of a ninth alternative stanchion member 220, in accordance with a sixteenth alternative embodiment of the present invention. In this view, the stanchion member 220 is provided with a curved cut-out portion 222 which envelopes only a portion of the top or upper portions of the side rail member 224.

Referring to FIG. 31, there is shown a partial perspective view of a tenth alternative stanchion member 230, in accordance with a seventeenth alternative embodiment of the present invention. In this view, the stanchion member 230 is streamlined and envelopes the top or upper portions of the side rail member 232.

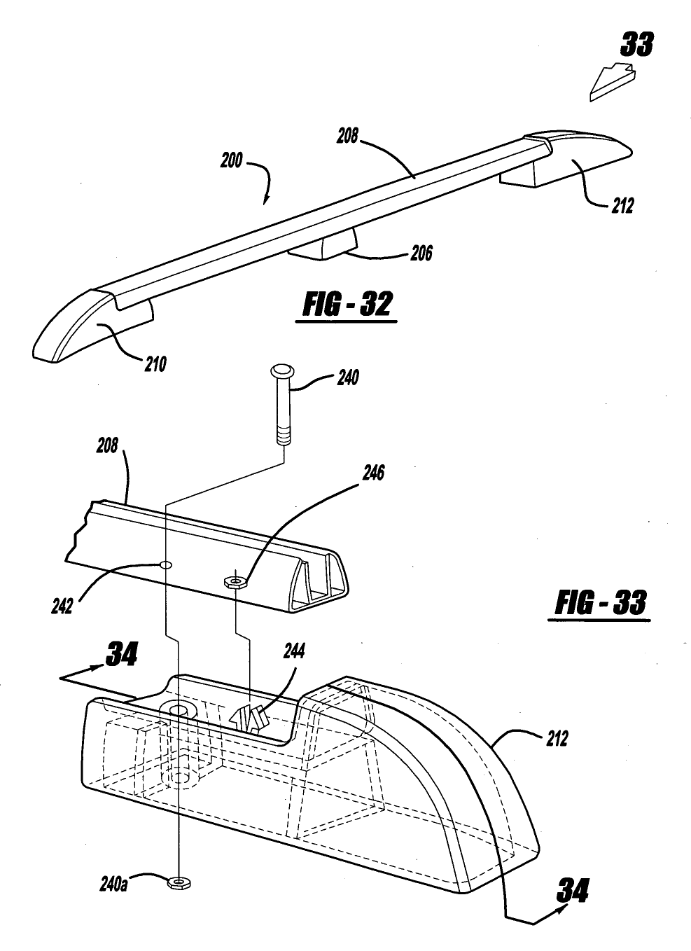

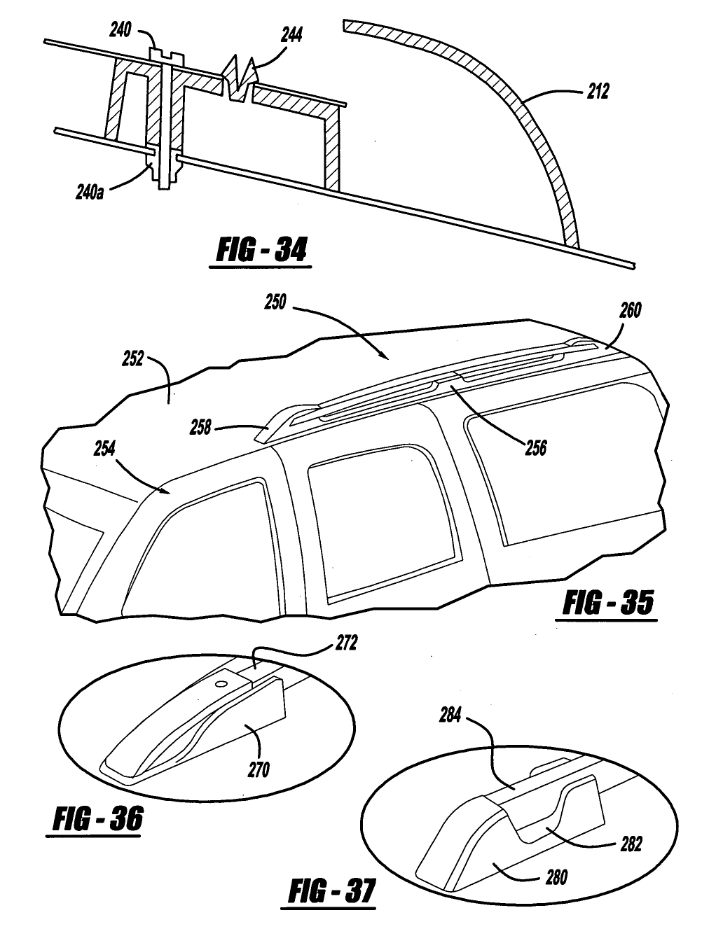

Referring to FIG. 32, there is shown a perspective view of the side rail system 200 depicted in FIG. 29, in accordance with an eighteenth alternative embodiment of the present invention.

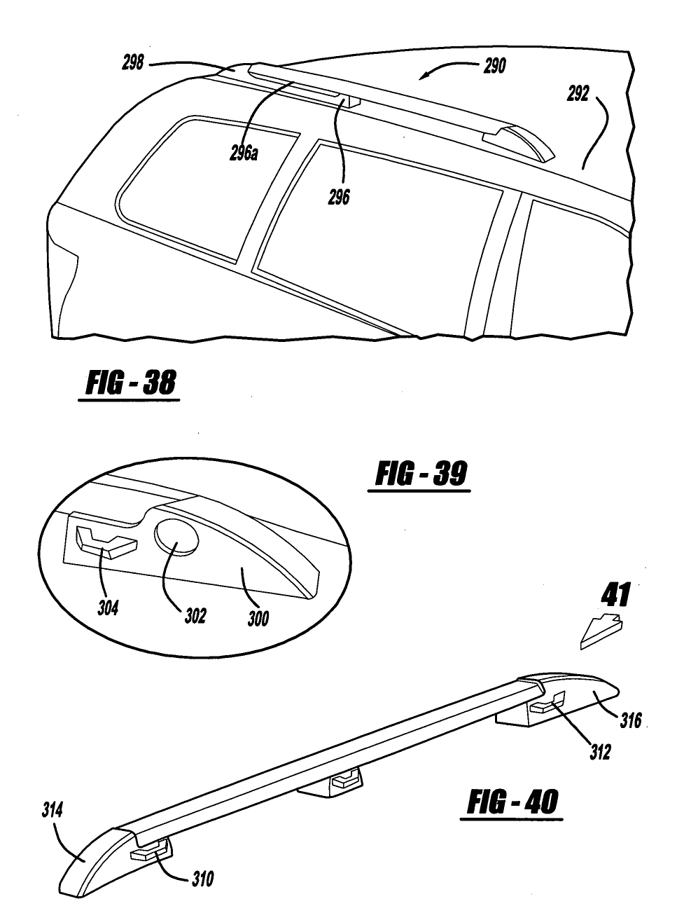

Referring to FIG. 33, there is shown a partial exploded view of the side rail system 200 depicted in FIG. 32, in accordance with an eighteenth alternative embodiment of the present invention. In this view, only one fastening member (e.g., a screw) 240 is inserted through an aperture 242 formed in a lower surface of the side rail member 208 and received into a bore (e.g., a threaded bore) formed on a surface of the stanchion members 210, 212, respectively, and inserted into a nut member 240a thus fastening the side rail member 208 to the stanchion members 210, 212, respectively. Additionally, a biasable locking member 244 can be provided on the stanchion members 210, 212, respectively, which is operable to engage another aperture 246 formed on the lower surface of the side rail member 208. Referring to FIG. 34, there is shown a partial sectional view taken along line 34-34 of FIG. 33, in accordance with an eighteenth alternative embodiment of the present invention.

Referring to FIG. 35, there is shown a partial perspective view of a sixth alternative side rail system 250 fastened to the roof portion 252 of a vehicle 254 on the driver's side, in accordance with a nineteenth alternative embodiment of the present invention. In this view, the support member 256 is essentially integrated into both the front and rear stanchion members 258, 260, respectively, to form a unitary member.

Referring to FIG. 36, there is shown a partial perspective view of an eleventh alternative stanchion member 270, in accordance with a twentieth alternative embodiment of the present invention. In this view, the stanchion member 270 is streamlined and envelopes the top or upper portions of the side rail member 272.

Referring to FIG. 37, there is shown a partial perspective view of a twelfth alternative stanchion member 280, in accordance with a twenty-first alternative embodiment of the present invention. In this view, the stanchion member 280 is provided with a curved cut-out portion 282 which envelopes only a portion of the top or upper portions of the side rail member 284.

Referring to FIG. 38, there is shown a partial perspective view of a sixth alternative side rail system 290 fastened to the roof portion 292 of a vehicle 294 on the passenger's side, in accordance with a twenty-second alternative embodiment of the present invention. In this view, the support member 296 is essentially integrated into the rear stanchion member 298 to form a unitary member; however, it is not a solid member as shown in FIG. 21, but rather the member contains an area defining a notch portion 296a.

Referring to FIG. 39, there is shown a perspective view of a tenth alternative stanchion member 300, in accordance with a twenty-third alternative embodiment of the present invention. In this view, the stanchion member 300 is provided with at least one area defining a notch portion 302, 304, respectively, which can be used for various purposes, including tie downs.

Referring to FIG. 40, there is shown a perspective view of the side rail system 290 depicted in FIG. 38, in accordance with a twenty-fourth alternative embodiment of the present invention. In this view, notch portions 310, 312, respectively, are provided on the stanchion members 314, 316, respectively.

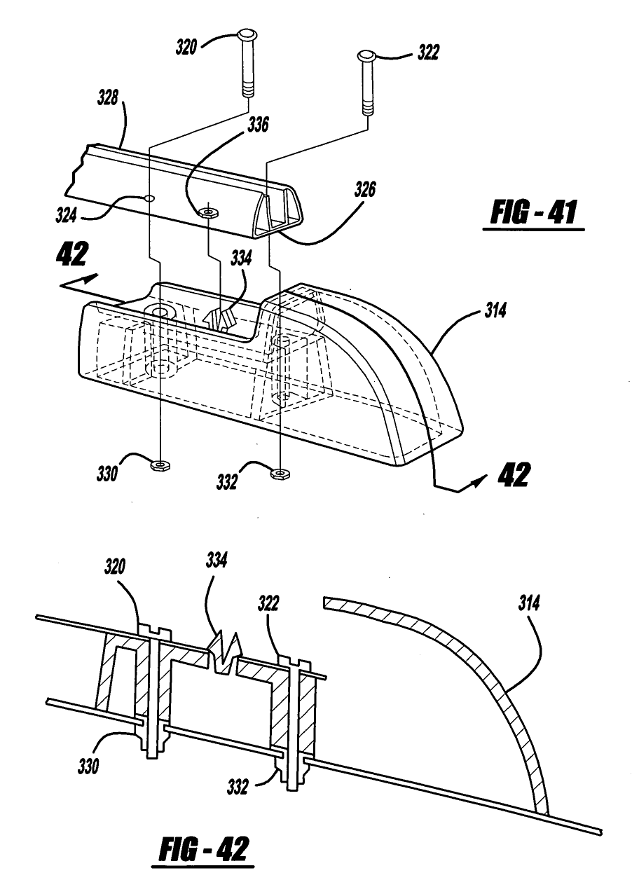

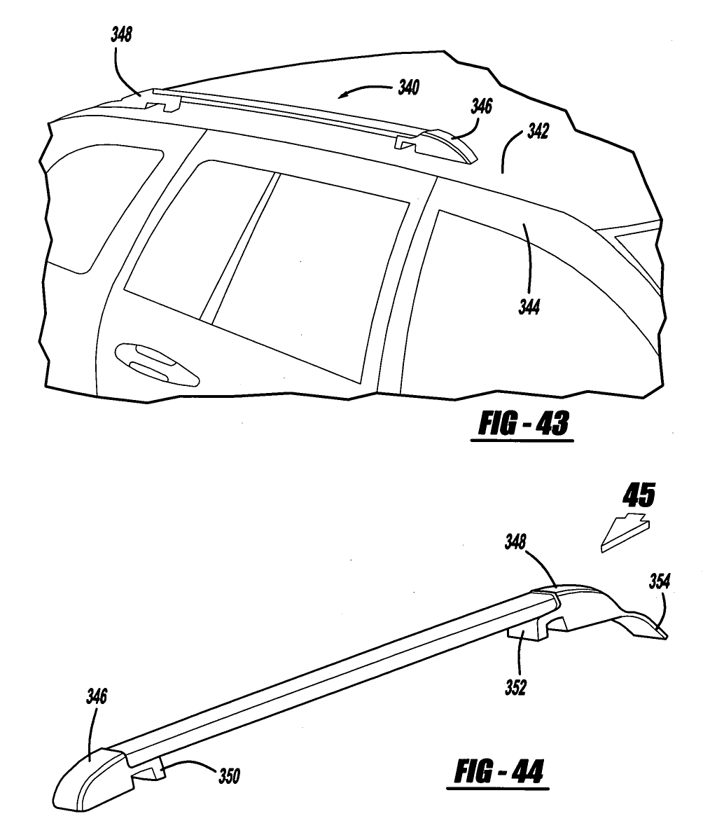

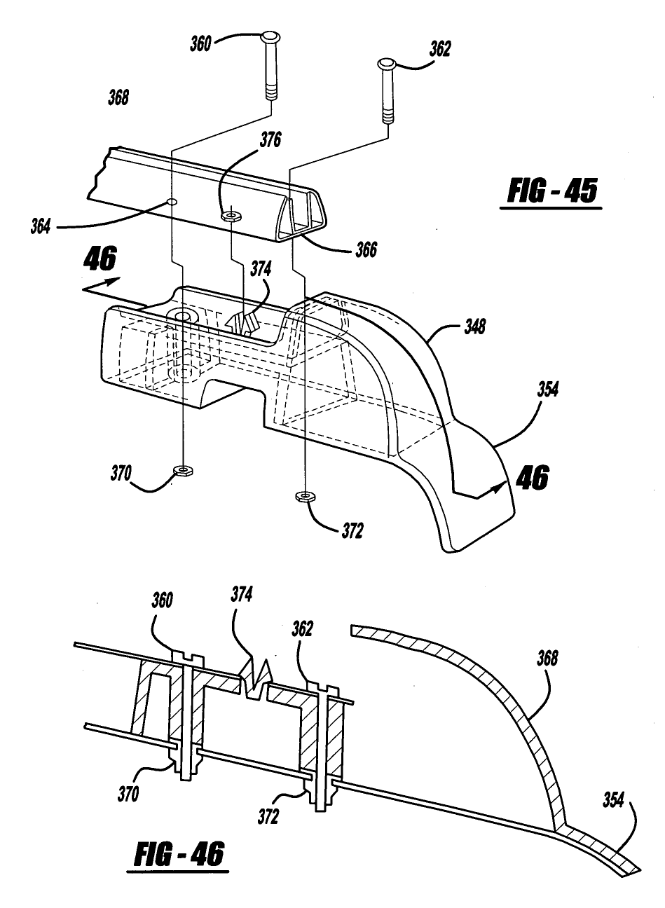

Referring to FIG. 41, there is shown a partial exploded view of the side rail system 290 depicted in FIG. 38, in accordance with a twenty-fourth alternative embodiment of the present invention. In this view, one or more fastening members (e.g., screws) 320, 322, respectively, are inserted through apertures 324, 326, respectively, formed in a lower surface of the side rail member 328 and received into bores (e.g., threaded bores) formed on a surface of the stanchion members 314 (only one is shown for purposes of clarity) and inserted into nut members, 330, 332, respectively, thus fastening the side rail member 328 to the stanchion members 314 (only one is shown for purposes of clarity). Additionally, a biasable locking member 334 can be provided on the stanchion members 314, 316, respectively, which is operable to engage another aperture 336 formed on the lower surface of the side rail member 328. Referring to FIG. 42, there is shown a partial sectional view taken along line 42-42 of FIG. 41, in accordance with a twenty-fourth alternative embodiment of the present invention.

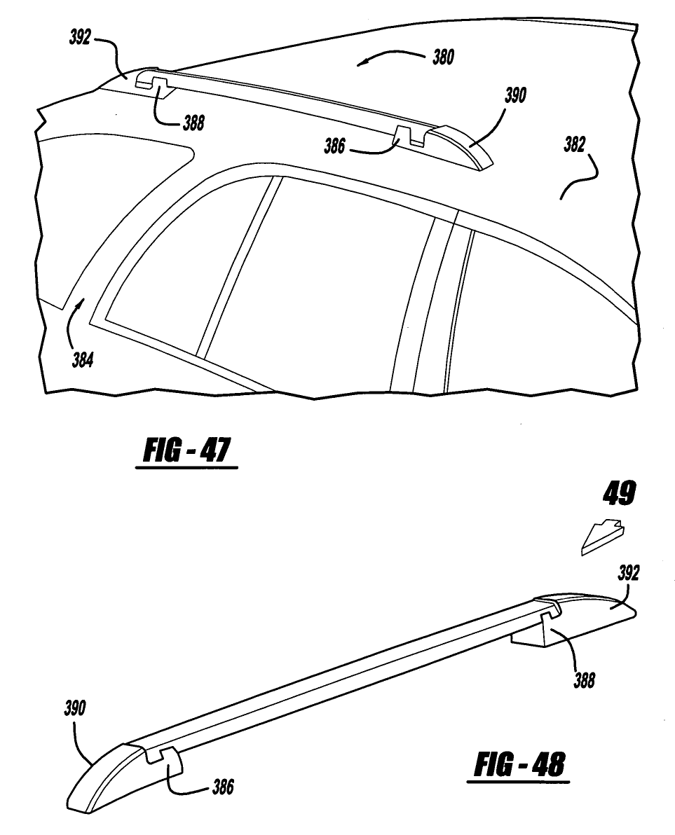

Referring to FIG. 43, there is shown a partial perspective view of a seventh alternative side rail system 340 fastened to the roof portion 342 of a vehicle 344 on the passenger's side, in accordance with a twenty-fifth alternative embodiment of the present invention. In this view, there is no support member; rather, the stanchion members 346, 348, respectively, provide the requisite support for the side rail member.

Referring to FIG. 44, there is shown a perspective view of the side rail system 340 depicted in FIG. 43, in accordance with a twenty-sixth alternative embodiment of the present invention. In this view, L-shaped portions 350, 352, respectively, are provided on the stanchion members 346, 348, respectively. Additionally, a curved extension member 354 extends from the rear stanchion member 348, and is especially suitable for use with vehicles with rounded or sloped cab portions.

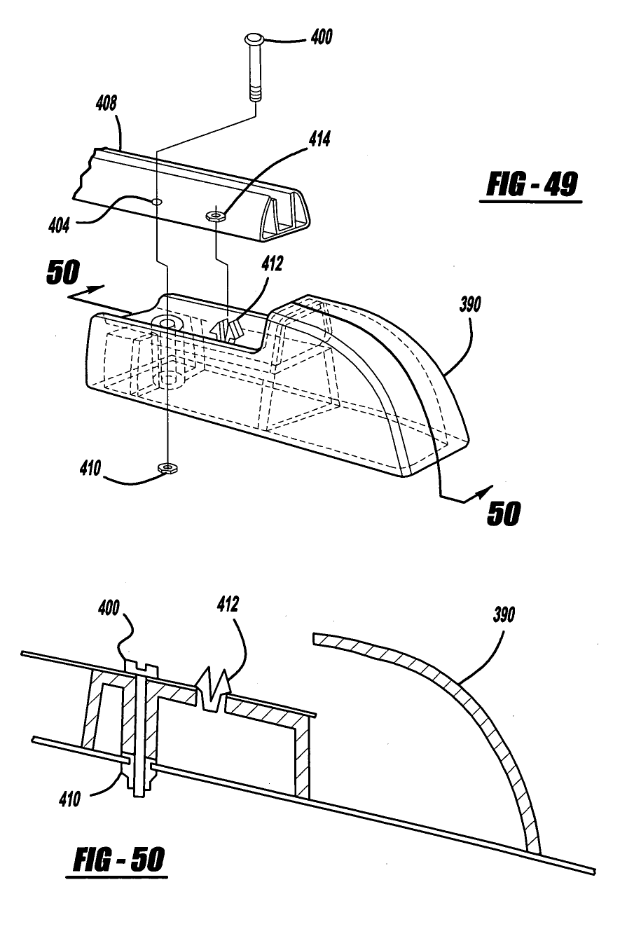

Referring to FIG. 45, there is shown a partial exploded view of the side rail system 340 depicted in FIG. 43, in accordance with a twenty-sixth alternative embodiment of the present invention. In this view, one or more fastening members (e.g., screws) 360, 362, respectively, are inserted through apertures 364, 366, respectively, formed in a lower surface of the side rail member 368 and received into bores (e.g., threaded bores) formed on a surface of the stanchion members 348 (only one is shown for purposes of clarity) and inserted into nut members, 370, 372, respectively, thus fastening the side rail member 368 to the stanchion members 348 (only one is shown for purposes of clarity). Additionally, a biasable locking member 374 can be provided on the stanchion members 346, 348, respectively, which is operable to engage another aperture 376 formed on the lower surface of the side rail member 368. Referring to FIG. 46, there is shown a partial sectional view taken along line 46-46 of FIG. 45, in accordance with a twenty-sixth alternative embodiment of the present invention.

Referring to FIG. 47, there is shown a partial perspective view of an eighth alternative side rail system 380 fastened to the roof portion 382 of a vehicle 384 on the passenger's side, in accordance with a twenty-seventh alternative embodiment of the present invention. In this view, L-shaped portions 386, 388, respectively, are provided on the stanchion members 390, 392, respectively.

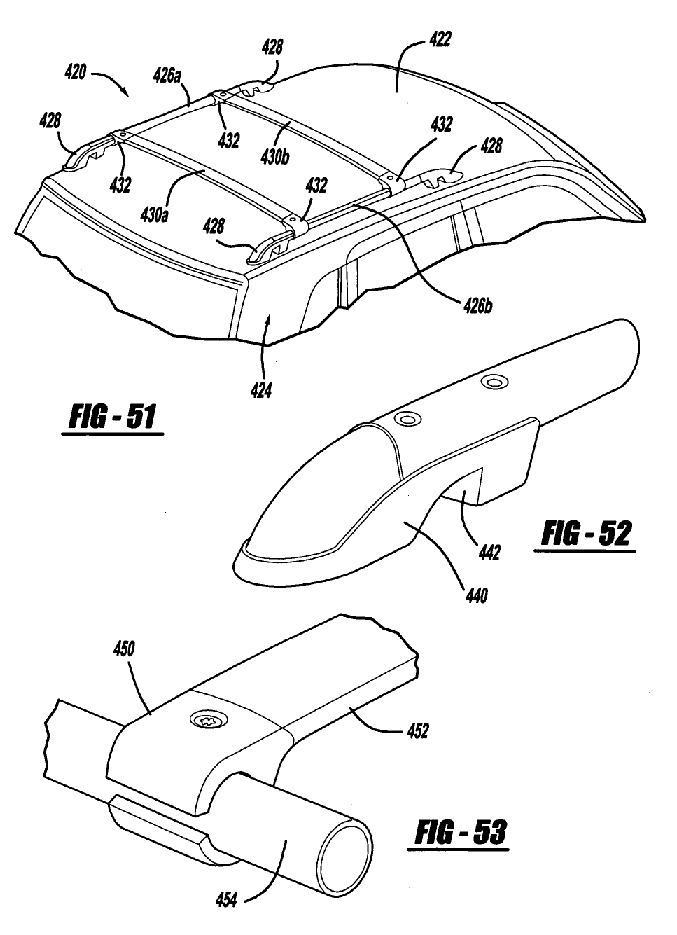

Referring to FIG. 48, there is shown a perspective view of the side rail system 380 depicted in FIG. 47, in accordance with a twenty-eighth alternative embodiment of the present invention.

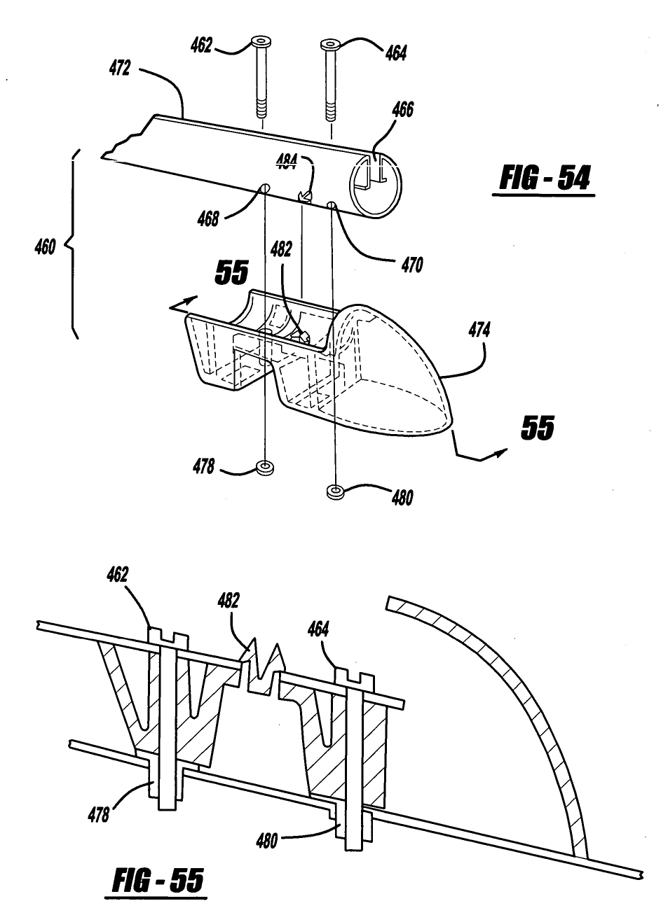

Referring to FIG. 49, there is shown a partial exploded view of the side rail system 380 depicted in FIG. 47, in accordance with a twenty-eighth alternative embodiment of the present invention. In this view, one or more fastening members (e.g., screws) 400 are inserted through an aperture 404 formed in a lower surface of the side rail member 408 and received into bores (e.g., threaded bores) formed on a surface of the stanchion members 390 (only one is shown for purposes of clarity) respectively, and inserted into a nut members 410 thus fastening the side rail member 408 to the stanchion members 390, 392, respectively. Additionally, a biasable locking member 412 can be provided on the stanchion members 390, 392, respectively, which is operable to engage another aperture 414 formed on the lower surface of the side rail member 408. Referring to FIG. 50, there is shown a partial sectional view taken along line 50-50 of FIG. 49, in accordance with a twenty-eighth alternative embodiment of the present invention.

Referring to FIG. 51, there is shown an alternative cargo rack system 420 fastened to a roof portion 422 of a vehicle 424, in accordance with a twenty-ninth alternative embodiment of the present invention. The system 420 preferably includes two side rail members 426a, 426b, respectively, at least one stanchion member 428, at least two cross rail members 430a, 430b, respectively, and at least one stanchion assembly 432 operable to connect the cross rail members 430a, 430b, respectively, to the side rail members 426a, 426b, respectively. The components of the system 420 are preferably substantially rounded.

The cross rail members of the present invention are preferably easily attached to the side rail members in any number of configurations. In accordance with a preferred embodiment of the present invention, the cross rail members are preferably fastened to a stanchion assembly with one or more fastening members (e.g., screws), wherein the stanchion assembly fits over the cross rail member, with the stanchion assembly being fastened to the side rail member with a clamp member that is preferably fastened to the stanchion assembly by one or more fastening members (e.g., screws). In this manner, any number of different combinations and different types of cargo rack systems may be easily attached to the vehicle's roof portion.

In accordance with a preferred embodiment of the present invention, the cross rail member is preferably an aerodynamic, structural load bearing section. The section preferably eliminates potential wind noise (e.g., with texture, paint, trip beads, elliptical contours, and the like). The cross rail member is preferably mechanically fastened to the stanchion assembly, e.g., with screws and/or the like.

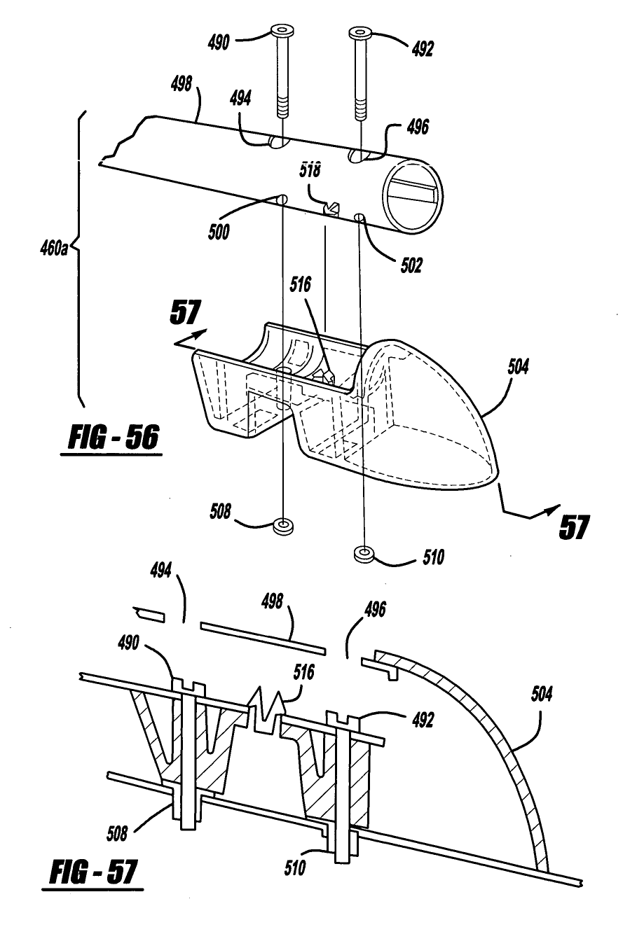

Referring to FIG. 52, there is shown a perspective view of an eleventh alternative stanchion member 440, in accordance with a thirtieth alternative embodiment of the present invention. In this view, the stanchion member 440 is preferably substantially rounded and provided with at least one area defining a notch portion 442, respectively, which can be used for various purposes, including tie downs.

Referring to FIG. 53, there is shown a partial exploded view of a first alternative stanchion assembly 450, in accordance with a thirty-first alternative embodiment of the present invention. The stanchion assembly 450 is preferably substantially rounded and is preferably fastened to the cross rail member 452 and envelopes the side rail member 454 so as to be operable to connect the two elements.

Referring to FIG. 54, there is shown a partial exploded view of a side rail system 460 of the cargo rack system 420 depicted in FIG. 51, in accordance with a thirty-first alternative embodiment of the present invention. In this view, one or more fastening members (e.g., screws) 462, 464, respectively, are inserted through a T-shaped groove 466 and into apertures 468, 470, respectively, formed in a lower surface of the side rail member 472 and received into bores (e.g., threaded bores) formed on a surface of the stanchion members 474 (only one is shown for purposes of clarity) and inserted into nut members, 478, 480, respectively, thus fastening the side rail member 472 to the stanchion members 474, 476, respectively. Additionally, a biasable locking member 482 can be provided on the stanchion members 474, 476, respectively, which is operable to engage another aperture 484 formed on the lower surface of the side rail member 472. Referring to FIG. 55, there is shown a partial sectional view taken along line 55-55 of FIG. 54, in accordance with a thirty-first alternative embodiment of the present invention.

Referring to FIG. 56, there is shown a partial exploded view of an alternative design 460a of the side rail system 460 of the cargo rack system 420 depicted in FIG. 51, in accordance with a thirty-second alternative embodiment of the present invention. In this view, one or more fastening members (e.g., screws) 490, 492, respectively, are inserted through apertures 494, 496, respectively, formed in an upper surface of the side rail member 498, through apertures 500, 502, respectively, formed in a lower surface of the side rail member 498, and received into bores (e.g., threaded bores) formed on a surface of the stanchion members 504 (only one is shown for purposes of clarity) and inserted into nut members, 508, 510, respectively, thus fastening the side rail member 498 to the stanchion members 504 (only one is shown for purposes of clarity). Additionally, a biasable locking member 516 can be provided on the stanchion members 504 (only one is shown for purposes of clarity), which is operable to engage another aperture 518 formed on the lower surface of the side rail member 498. Referring to FIG. 57, there is shown a partial sectional view taken along line 57-57 of FIG. 56, in accordance with a thirty-second alternative embodiment of the present invention.

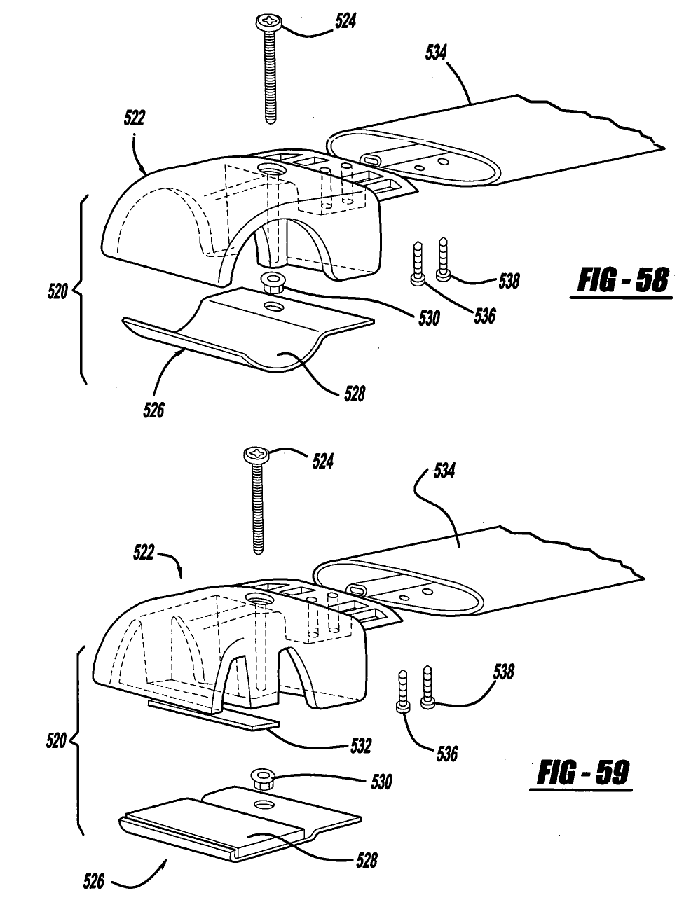

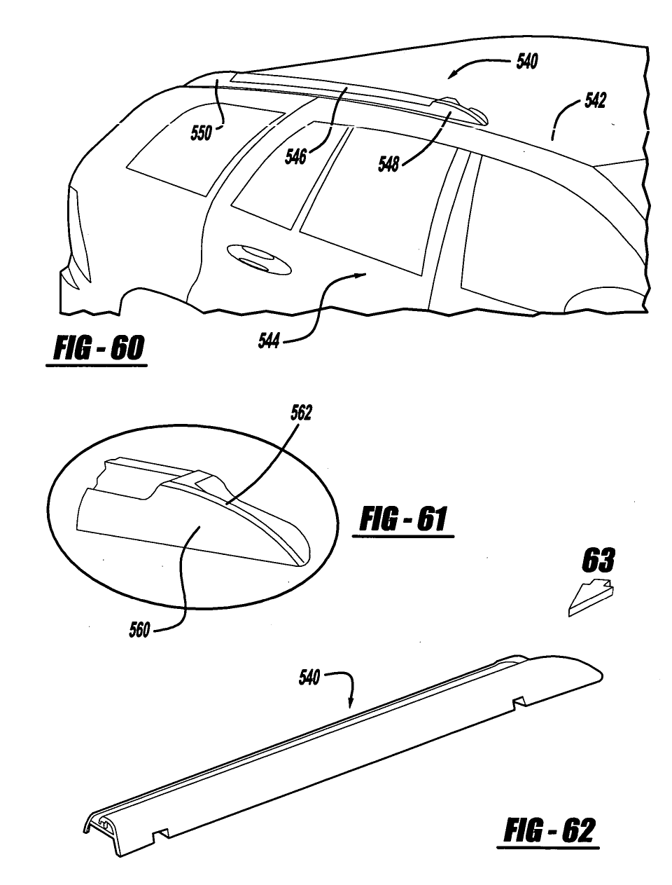

Referring to FIG. 58, there is shown a partial exploded view of a second alternative stanchion assembly 520 of the cargo rack system 420 depicted in FIG. 51, in accordance with a thirty-third alternative embodiment of the present invention.

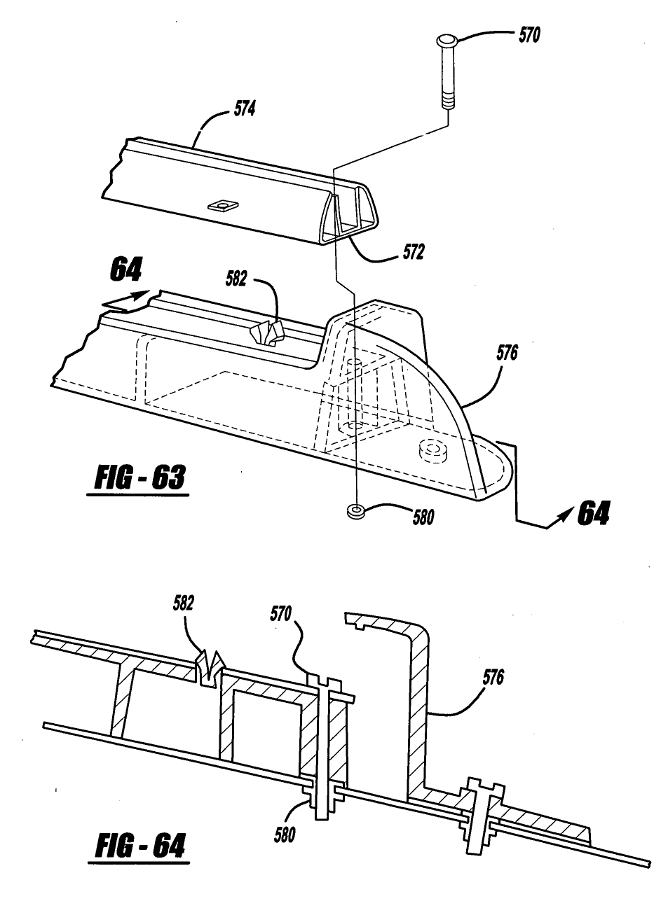

The stanchion assembly 520 preferably includes the stanchion 522, clamping screw 524 (e.g., a thumbwheel), and clamp subassembly 526. The stanchion assembly 520 preferably clamps over the side rail member for easy installation and removal. In accordance with a preferred embodiment of the present invention, the clamp subassembly 526 preferably includes a clamp 528, nut 530 and anti-skid pad 532 (as shown in FIG. 59). The clamp subassembly 526 preferably securely holds the stanchion 522 in a desired location along the length of the side rail member (not shown). The clamp 528, in conjunction with the clamping screw 524 and the nut 530, provides the compression force to sandwich the side rail member (not shown) between the clamp 528 and the bottom surface of the stanchion assembly 520. The anti-skid pad 532 preferably provides the required resistance to slip of the cross rail member 534 along the length of the side rail member (not shown), e.g., when loaded and a panic stop occurs. The nut 530 is preferably a threaded fastener that is post installed into the clamp 528 and serves as the threaded counterpart of the clamping screw 524. The clamping screw 524, as mentioned above in conjunction with the nut 530 and the clamp 528, provides the required compression force to secure the cross rail member 534 in a desired location along the length of the side rail member (not shown). The stanchion assembly 520 preferably provides the housing for the clamping mechanism (e.g., clamp subassembly 526 and clamping screw 524). The stanchion assembly 520 also preferably provides the required structural connection of the cross rail member 534 to the side rail member (not shown). By way of a non-limiting example, one or more fastening members (e.g., screws) 536, 538, respectively, can be employed to secure a portion of the cross rail member 534 (e.g., an end portion) to a portion of the stanchion assembly 520 (e.g., an end portion), such a portion of the stanchion assembly 520 being received in a hollow portion of the cross rail member 534. The stanchion assembly 520 preferably adds aesthetic appeal to the system and it preferably includes integrated functional features such as but not limited to tie loops.

Referring to FIG. 60, there is shown a partial perspective view of a ninth alternative side rail system 540 fastened to the roof portion 542 of a vehicle 544 on the passenger's side, in accordance with a thirty-fifth alternative embodiment of the present invention. In this view, the support member 546 is essentially integrated into the front and rear stanchion members 548, 550, respectively, to form a unitary member. Furthermore, the support member 546 and both of the stanchion members 548, 550, respectively, are flush with the surface of the roof portion 542.

Referring to FIG. 61, there is shown a perspective view of an eleventh alternative stanchion member 560, in accordance with a thirty-sixth alternative embodiment of the present invention. In this view, the stanchion member 560 is provided with a vertically upstanding wall portion 562.

Referring to FIG. 62, there is shown a perspective view of the side rail system 540 depicted in FIG. 60, in accordance with a thirty-seventh alternative embodiment of the present invention.

Referring to FIG. 63, there is shown a partial exploded view of the side rail system 540 depicted in FIG. 60, in accordance with a thirty-seventh alternative embodiment of the present invention. In this view, one fastening member (e.g., a screw) 570 is inserted through an aperture 572 formed in a lower surface of the side rail member 574 and received into a bore (e.g., a threaded bore) formed on a surface of the stanchion members 576 504 (only one is shown for purposes of clarity) and inserted into a nut member 580 thus fastening the side rail member 574 to the stanchion members 576 504 (only one is shown for purposes of clarity). Additionally, a biasable locking member 582 can be provided on the stanchion members 576, 578, respectively, which is operable to engage another aperture 584 formed on the lower surface of the side rail member 574. Referring to FIG. 64, there is shown a partial sectional view taken along line 64-64 of FIG. 63, in accordance with a thirty-seventh alternative embodiment of the present invention.

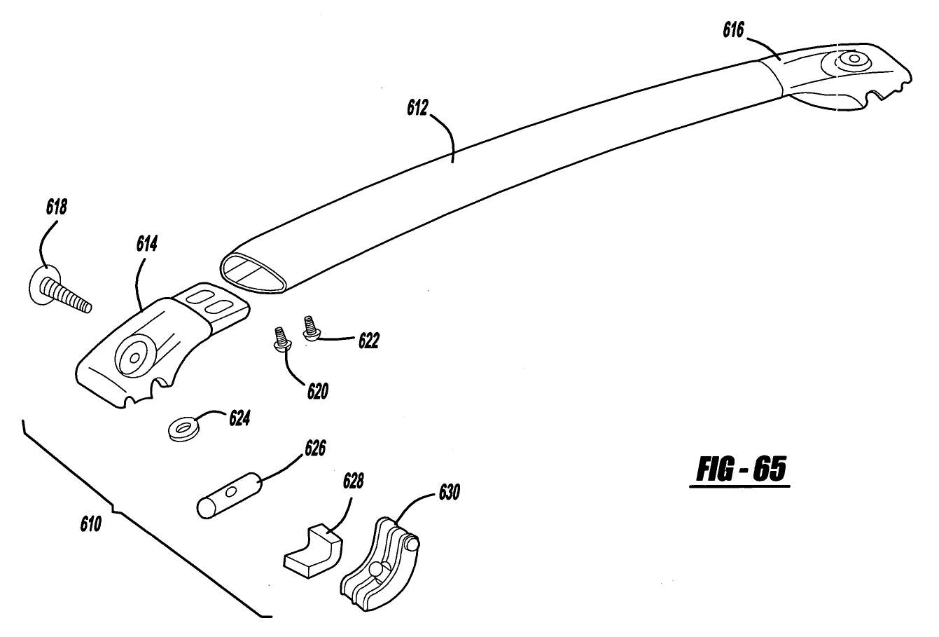

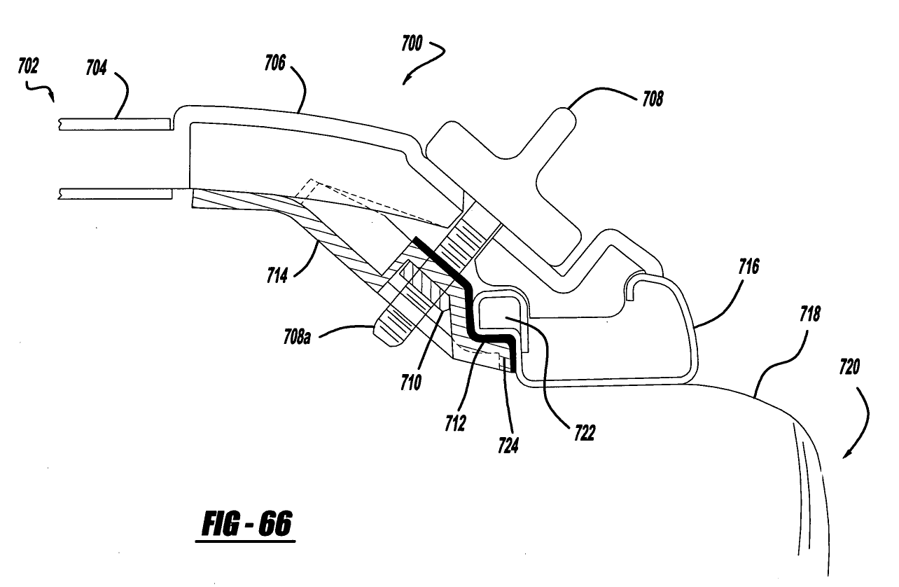

Referring to FIG. 65, there is shown a cross rail system 610, in accordance with a thirty-eighth embodiment of the present invention. The side rail system 610 preferably includes: a cross rail member 612; at least one, and more preferably at least two, stanchion members 614, 616, respectively; a securing member such as but not limited to a thumb wheel member 618; at least one, and more preferably at least two, optional fastening members such as but not limited to screws 620, 622, respectively; a retaining clip member 624; a threaded dowel member 626; a clamp pad member 628; and a clamp member 630. It should be appreciated that a like number of components would be associated with the opposing stanchion member 616.

The stanchion members 614, 616, respectively, are preferably received into the respective hollow ends of the cross rail member 612. Once the stanchion members 614, 616, respectively, are properly positioned on the cross rail member 612, the screws 620, 622, respectively, are employed to fasten the stanchions 614, 616, respectively, to the cross rail member 612.

The retaining clip member 624, threaded dowel member 626, clamp pad member 628, and clamp member 630 are brought into engagement together, whereupon the thumb wheel member 618 is threadedly inserted through the threaded dowel pin member 626. As will be explained herein, the clamp member 630 is preferably configured so as to abut a side rail member (not shown) such that when the thumb wheel member 618 engages the clamp member 630, the cross rail system 610 is sturdily fastened to the side rail member.

Referring to FIG. 66, there is shown a cargo rack system 700, in accordance with a thirty-ninth embodiment of the present invention. In this system 700, the side rail system 702 is somewhat similar to the side rail system depicted in FIG. 65.

The side rail system 702 preferably includes: a cross rail member 704; at least one, and more preferably at least two, stanchion members 706 (only one stanchion member is shown for purposes of clarity); a securing member such as but not limited to a thumb wheel member 708 having a threaded stud portion 708a (e.g., a M6 thumb wheel stud); a threaded plate member 710 (e.g., a M6 threaded plate); a rubber boot member 712; and a clamp member 714. It should be appreciated that a like number of components would be associated with the opposing non-depicted stanchion member.

As with the previously described embodiment, the stanchion members 706 are preferably received into the respective hollow ends of the cross rail member 704. Once the stanchion members 706 are properly positioned on the cross rail member 704, the threaded plate member 710, rubber boot member 712, and the clamp member 714 are brought into engagement together, whereupon the thumb wheel member 708 is threadedly inserted through the threaded plate member 710. As with the previously described embodiment, the clamp member 714 is preferably configured so as to abut a side rail member 716 such that when the thumb wheel member 708 engages the clamp member 714, the cross rail system 702 is sturdily fastened to the side rail member 716. The side rail member 716 is preferably fastened to the roof portion 718 of a vehicle 720. The side rail member 716 is preferably comprised of metallic materials and is provided with an open top channel portion 716a for access, e.g., to tie-down hardware for the vehicle 720.

More specifically, the side rail member 716 is preferably provided with a substantially D-shaped portion 722 formed on a side portion (e.g., inboard side) thereof. The D-shaped portion 722 is intended to abuttingly engage a substantially L-shaped flange portion 724 extending from the clamp member 714, such that when the thumb wheel member 708 engages the threaded plate member 710, the L-shaped flange portion 724 cannot be lifted from up under the D-shaped portion 722. In this manner, the cross rail system 702 can be securely fastened to the side rail member 716.

In this manner, the cross rail member 704, e.g., when fastened to the stanchion member 706 and the clamp member 714, can be easily positioned at an infinite number of positions along the side rail member 716 due, in part, because the L-shaped flange portion 724 can easily slide past the D-shaped portion 722 and be repositioned without interference from any center supports of the side rail member 716. Alternately, the cross rail member 704 can be positioned at a predetermined number of positions relative to the side rail member 716.

The back portion of the clamp member 714, which is preferably comprised of reinforced nylon, preferably covers any ribbing on the bottom of the stanchion member 706. Furthermore, the threaded plate member 710 is not secured to the clamp member 714. Rather, the bottom portion of the rubber boot member 712 holds the threaded plate member 710 in location for transport inside of the thumb wheel member 708.

Accordingly, the present invention provides a lightweight, aerodynamic metal side rail member that has been optimized to reduce the overall strip width and cross-sectional area, and that will accommodate a standard M6 weld stud and mating fastener and also has a vertical and horizontal clamping surface for the attachment of load bearing cross rail members.

Accordingly, the simplification and standardization of the cargo rack system designs of the present invention is preferably based on current industry best practices. Standardization and carryover of the rail sections and cross rail mechanism can be achieved through the present invention. As previously noted, the side rail sections can be designed so it can be used as either a raised or flush rack system. Additionally, the side rail sections can be designed to be an exposed rail for alternative finish applications, e.g., to change the overall look of the rack system by changing the finishes. Furthermore, the ability to easily remove the cross rails eliminate possible wind noise and improve vehicle fuel efficiency when the rails are not in use.

The simplicity of the overall design of the various systems and components thereof of the present invention is also apparent. For example, there is an infinite number of ways to adjust the cross rail assemblies along the length on the side rails. Additionally, improved system strength is achieved through simplicity of design and fewer components. Furthermore, attachment component styling can be changed from one vehicle to another to change the overall appearance of the cargo rack system.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A side rail system, comprising:
a side rail member;
a stanchion member, wherein the side rail member is operable to receive a portion of the stanchion member; and
a clamp member in abutting engagement with the stanchion member, the clamp member having a flange portion extending therefrom.

2. The invention according to claim 1, wherein the flange portion is substantially L-shaped.

3. The invention according to claim 1, further comprising a threaded plate member in abutting engagement with a surface of the clamp member.

4. The invention according to claim 3, further comprising a fastening member, wherein the fastening member is operable to engage the threaded plate member.

5. The invention according to claim 4, wherein the fastening member includes an externally threaded stud portion extending therefrom.

6. The invention according to claim 1, further comprising a rubber boot member engaged to a portion of the externally threaded stud portion of the fastening member.

7. The invention according to claim 1, wherein the clamp member is operable to engage a side rail member.

8. The invention according to claim 7, wherein the side rail member is fastened to a roof portion of a vehicle.

9. The invention according to claim 7, wherein a substantially L-shaped flange portion of the clamp member is operable to engage the side rail member.

10. The invention according to claim 9, wherein a substantially D-shaped portion of the side rail member is operable to engage the L-shaped flange portion of the clamp member.

11. A cargo rack system, comprising:
a side rail member;
a stanchion member, wherein the side rail member is operable to receive a portion of the stanchion member;
a clamp member in abutting engagement with the stanchion member, the clamp member having a flange portion extending therefrom; and
a side rail member, wherein the flange portion is operable to engage a portion of the side rail member.

12. The invention according to claim 11, wherein the flange portion is substantially L-shaped.

13. The invention according to claim 11, further comprising a threaded plate member in abutting engagement with a surface of the clamp member.

14. The invention according to claim 13, further comprising a fastening member, wherein the fastening member is operable to engage the threaded plate member.

15. The invention according to claim 14, wherein the fastening member includes an externally threaded stud portion extending therefrom.

16. The invention according to claim 11, further comprising a rubber boot member engaged to a portion of the externally threaded stud portion of the fastening member.

17. The invention according to claim 11, wherein the side rail member is fastened to a roof portion of a vehicle.

18. The invention according to claim 11, wherein a substantially L-shaped flange portion of the clamp member is operable to engage the side rail member.

19. The invention according to claim 18, wherein a substantially D-shaped portion of the side rail member is operable to engage the L-shaped flange portion of the clamp member.

20. A cargo rack system, comprising:
a side rail member;
a stanchion member, wherein the side rail member is operable to receive a portion of the stanchion member;
a clamp member in abutting engagement with the stanchion member, the clamp member having a flange portion extending therefrom;
a side rail member, wherein the flange portion is operable to engage a portion of the side rail member, wherein the flange portion is substantially L-shaped, wherein a substantially D-shaped portion of the side rail member is operable to engage the L-shaped flange portion of the clamp member;
a threaded plate member in abutting engagement with a surface of the clamp member; and
a fastening member, wherein the fastening member is operable to engage the threaded plate member, wherein the fastening member includes an externally threaded stud portion extending therefrom.
